(19) United States
(12) Patent Application Publication
(10) Pub. No.: US 2010/0035087 A1
(43) Pub. Date: Feb. 11, 2010

(54) PROCESS FOR PRODUCING FERROMAGNETIC METAL PARTICLES AND MAGNETIC RECORDING MEDIUM

(75) Inventors: Hiroko Morii, Hiroshima-ken (JP); Keisuke Iwasaki, Hiroshima-ken (JP); Seiji Ishitani, Hiroshima-ken (JP); Mineko Ohsugi, Hiroshima-ken (JP); Shinji Horie, Otake-shi (JP); Toshiharu Harada, Yamaguchi-ken (JP); Takehiro Matsuo, Yamaguchi-ken (JP); Yosuke Yamamoto, Yamaguchi-ken (JP); Kazuyuki Hayashi, Hiroshima-ken (JP)

Correspondence Address: NIXON & VANDERHYE, PC, 901 NORTH GLEBE ROAD, 11TH FLOOR, ARLINGTON, VA, 22203, US

(73) Assignee: TODA KOGYO CORPORATION, Otake-shi (JP)

(21) Appl. No.: 12/535,978

(22) Filed: Aug. 5, 2009

(30) Foreign Application Priority Data
Aug. 8, 2008 (JP) 2008-205012
Aug. 8, 2008 (JP) 2008-205013
Oct. 15, 2008 (JP) 2008-266731
Oct. 15, 2008 (JP) 2008-266732

(51) Int. Cl. G11B 5/712; B22F 9/20; B32B 15/02

(52) U.S. Cl. 428/840; 75/348; 428/546

(57) ABSTRACT

The present invention relates to ferromagnetic metal particles having an average major axis diameter (L) of 10 to 100 nm which satisfy a relationship between the average major axis diameter (L) and a particle SFD represented by the following formula:

Particle SFD≦0.0001 L²−0.0217 L+1.75;

a process for producing the ferromagnetic metal particles; and a magnetic recording medium using the ferromagnetic metal particles.

### BACKGROUND OF THE INVENTION

The present invention relates to ferromagnetic metal particles which have a uniform particle size and a less content of ultrafine particles, are prevented from suffering from aggregation owing to sintering therebetween, and exhibit a good dispersibility and a good particle switching field distribution SFD, although they are fine particles, in particular, such fine particles having an average major axis diameter as small as not more than 100 nm; a process for producing the ferromagnetic metal particles; and a magnetic recording medium using the ferromagnetic metal particles which have a good surface smoothness and an excellent switching field distribution SFD.

Conventionally, magnetic recording techniques have been extensively used in various applications such as audio and video equipments and computers. In recent years, in the magnetic recording equipments, there is an increasing demand for miniaturization, lightening, recording-time prolongation and increase in memory capacity. In recording media used in these equipments, it has been increasingly required to further improve a recording density thereof.

In order to perform high-density recording on the conventional magnetic recording media, it has been required that the media have a high C/N ratio, a low noise (N) and a high reproduction output (C). Also, in recent years, high-sensitivity heads such as a magneto-resistance-type head (MR head) and a giant magneto-resistance type head (GMR head) have been developed instead of conventional induction-type magnetic heads. Since these magneto-resistance-type heads can readily produce a high reproduction output as compared to the conventional induction-type magnetic heads, reduction of noise is more important than increase in output thereof in order to attain a high C/N ratio.

The noise of magnetic recording media is generally classified into particle-based noise and surface noise that is caused due to surface properties of the magnetic recording media. The particle-based noise is largely affected by the size of particles used in the magnetic recording media and can be more advantageously reduced as the particle size becomes finer. Therefore, it is required that the particle size of magnetic particles used in the magnetic recording media is as small as possible.

However, it is known that as the particle size of the magnetic particles becomes finer, the volume of crystal grains thereof is decreased, so that the magnetic particles tend to lose magnetism owing to unstable magnetization of the crystals (super-paramagnetism). For this reason, it is important to reduce a content of ultrafine particles in the magnetic particles. In addition, the finer magnetic particles have a broader particle size distribution and are more fluctuated in coercive force value Hc, thereby causing such a tendency that the switching field distribution SFD (Switching Field Distribution) thereof is increased. Therefore, it has been required that the magnetic particles have a uniform particle size and a reduced switching field distribution SFD.

In general, magnetic metal particles comprising iron as a main component are produced by subjecting goethite particles as a starting material (precursor) to heat-dehydration and heat-reduction treatments. Therefore, in order to obtain fine ferromagnetic metal particles, it is required to reduce the size of the goethite particles to provide fine particles thereof. However, when reducing the size of the particles up to fine particles, the surface area of the particles is increased, so that heat-calcined and heat-reduced particles tend to suffer from not only sintering between the particles but also breakage of shape of the particles, resulting in such a problem that the resulting ferromagnetic metal particles tend to be deteriorated in magnetic properties. To avoid such a problem, a large amount of an anti-sintering agent has been incorporated into the goethite particles as the precursor in order to prevent sintering therebetween. In addition, it is known that inclusion of Co is effective to improve magnetic properties of the resulting particles. Therefore, it is essentially required to add Co to the magnetic metal particles comprising iron as a main component.

On the other hand, with respect to the surface noise, it is important to improve a surface smoothness of the magnetic recording media, and it is inevitably required to improve a dispersibility of the magnetic particles in a magnetic coating material and an orientation property and a filling property of the magnetic particles in a magnetic recording layer. However, as described above, the finer particles tend to suffer from sintering therebetween upon subjecting the particles to heat-calcination and heat-reduction treatments, and further coarse aggregated particles tend to be produced owing to the sintering, resulting in poor dispersibility thereof in the magnetic coating material. Therefore, it may be difficult to obtain magnetic recording media having a good surface smoothness.

Conventionally, for the purpose of obtaining magnetic metal particles capable of providing a tape having a sharp coercive force distribution which exhibit excellent dispersibility and orientation property, there has been proposed a process for producing the magnetic metal particles in which an atmosphere comprising steam in an amount of 80 to 100% is used as the atmosphere for heat-dehydration treatment of the goethite particles (Japanese Patent Application Laid-Open (KOKAI) No. 6-136412 (1994)).

Conventionally, for the purpose of obtaining magnetic metal particles which are less fluctuated in particle size and shape, and prevented from exhibiting a broad particle size distribution by reducing a content of ultrafine particles therein, there has been proposed a process for producing the magnetic metal particles by using, as a starting material, goethite particles obtained by neutralizing a Co salt-containing iron salt solution with an alkali under specific conditions upon conducting a production reaction of goethite (Japanese Patent Application Laid-Open (KOKAI) No. 2005-277094).

Also, for the purpose of obtaining magnetic metal particles having a uniform particle shape and a uniform particle size distribution, there have been proposed magnetic metal particles having a specific shape which are produced by using, as a starting material, goethite particles obtained by rapidly growing core crystals of goethite, adding aluminum to the core crystals in the range of a specific oxidation percentage to allow growth of goethite thereon, and after completion of the oxidation, coating the resulting particles with rare earth element (Japanese Patent Application Laid-Open (KOKAI) No. 2007-81227).

Further, for the purpose of improving magnetic properties of magnetic metal particles, there have been proposed magnetic metal particles from which an anti-sintering agent is removed by reacting a reducing agent therewith (Japanese Patent Application Laid-Open (KOKAI) No. 2007-294841).

In addition, for the purpose of obtaining magnetic metal particles which are prevented from suffering from aggregation and exhibit a good dispersibility, there have been proposed magnetic metal particles which are exposed to steam to restrict an amount of surface functional groups into a specific range (Japanese Patent Application Laid-Open (KOKAI) No. 2008-84900).

Also, for the purpose of obtaining magnetic metal particles which are prevented from suffering from sintering therebetween, there have been proposed magnetic metal particles which are produced by using, as a starting material, a precursor (goethite particles) comprising Co, Al and R (R: at least one rare earth element including Y) which are bonded to a specific position thereof (Japanese Patent Application Laid-Open (KOKAI) Nos. 11-130439 (1999) and 2007-194666).

Further, for the purpose of obtaining magnetic metal particles in the form of fine particles having a high magnetic anisotropy, there has been proposed a process for producing the magnetic metal particles by using, as a starting material, acicular goethite particles comprising Co, Al and R (rare earth elements including Y) in specific amounts (Japanese Patent Application Laid-Open (KOKAI) No. 2007-246393).

In addition, for the purpose of obtaining magnetic metal particles having an adequate coercive force value as well as good dispersibility and oxidation stability although they are fine particles, there have been proposed magnetic metal particles which are produced by using, as a starting material, goethite particles in which an outermost layer comprising Co and a rare earth element compound is formed on the surface of the respective Co-containing goethite particles (Japanese Patent Application Laid-Open (KOKAI) No. 2003-59707).

At present, it has been strongly required to provide ferromagnetic metal particles which are prevented from suffering from aggregation owing to sintering therebetween, and exhibit a good dispersibility although they are fine particles, in particular, such fine particles having an average major axis diameter as small as not more than 100 nm, as well as ferromagnetic metal particles which have a less content of ultrafine particles, a uniform particle size and a good particle switching field distribution SFD, and are excellent in magnetic properties, although they are fine particles. However, the process for producing the ferromagnetic metal particles capable of fully satisfying the above various properties has not been attained until now.

That is, the techniques described in the above-mentioned patent documents have failed to attain a sufficient anti-sintering effect when subjecting goethite particles in the form of fine particles to heat-dehydration and heat-reduction treatments to obtain the ferromagnetic metal particles. Namely, since the amount of soluble Co from the particles is not reduced to a satisfactory extent, the resulting ferromagnetic metal particles tend to suffer from sintering between the particles, and exhibit a poor dispersibility in a magnetic coating material owing to coarse aggregated particles formed by the sintering, so that it may be difficult to obtain magnetic recording media having a good surface smoothness.

Also, in the techniques described in the above-mentioned patent documents, there is no description that goethite particles are previously heat-treated at a temperature of 100 to 250° C. upon obtaining ferromagnetic metal particles by subjecting the goethite particles to heat-dehydration and heat-reduction treatments. Therefore, since the dehydration of the goethite particles is initiated under such a condition that goethite ultrafine particles are still present therein, sintering between the particles tends to be caused, so that it may be difficult to obtain ferromagnetic metal particles having a less content of ultrafine particles and a uniform particle size as well as an improved particle switching field distribution SFD.

In addition, in the techniques described in the above-mentioned patent documents, there is no description that an Al compound is intermittently added in at least two divided parts according to the progress of stage of the oxidation reaction when obtaining ferromagnetic metal particles by subjecting goethite particles in the form of fine particles to heat-dehydration and heat-reduction treatments. Therefore, as described in the below-mentioned Comparative Examples, since the conventional ferromagnetic metal particles obtained by adding the Al compound either at one time or gradually tend to be broken in particle shape, it may be difficult to obtain ferromagnetic metal particles having a less content of ultrafine particles and a uniform particle size as well as excellent magnetic properties.

### SUMMARY OF THE INVENTION

Consequently, an object or technical task of the present invention is to provide ferromagnetic metal particles which have a uniform particle size, are prevented from suffering from aggregation owing to sintering therebetween, exhibit a good dispersibility, a less content of ultrafine particles and a good particle switching field distribution SFD, and are excellent in magnetic properties, although they are fine particles, in particular, such fine particles having an average major axis diameter as small as not more than 100 nm.

As a result of the present inventors' earnest study for solving the above problems, the following findings have been attained. The present invention has been attained on the basis of these findings.

That is, it has been found that in the process for producing ferromagnetic metal particles by heat-treating goethite particles to obtain hematite particles and then heat-reducing the hematite particles, when the heat treatment of the goethite particles is conducted in a non-reducing atmosphere at a temperature of 100 to 250° C. and then under such a condition that a steam concentration is not less than 90% by volume at a temperature of 300 to 650° C., it is possible to obtain ferromagnetic metal particles having a less content of ultrafine particles and a good particle switching field distribution SFD.

Further, it has been found that in the above process for producing ferromagnetic metal particles by heat-treating goethite particles to obtain hematite particles and then heat-reducing the hematite particles, as the goethite particles, there are preferably used such goethite particles which are produced by reacting a mixed alkali aqueous solution of an alkali hydrogencarbonate aqueous solution or an alkali carbonate aqueous solution and an alkali hydroxide aqueous solution with a ferrous salt aqueous solution to obtain a water suspension comprising a ferrous-containing precipitate; aging the water suspension comprising the ferrous-containing precipitate in a non-oxidative atmosphere; thereafter producing goethite core crystal particles by an oxidizing agent; allowing a goethite layer to be grown on the surface of the respective core crystal particles, followed by washing the resulting particles with water; and then coating the surface of the thus obtained goethite particles with an anti-sintering agent.

Further, it has been found that when using, as a starting material, goethite particles having a soluble Co content of not more than 20 ppm and subjecting the goethite particles to heat-dehydration and heat-reduction treatments, it is possible to obtain ferromagnetic metal particles which are prevented from suffering from aggregation owing to sintering therebetween and exhibit a good dispersibility.

In addition, it has been found that when intermittently adding an Al compound in two or more divided parts according to the progress of stage of the oxidation reaction upon production reaction of goethite particles and subjecting the resulting goethite particles to heat-dehydration and heat-reduction treatments, it is possible to obtain ferromagnetic metal particles having a less content of ultrafine particles and a uniform particle size.

That is, according to the present invention, there is provided ferromagnetic metal particles having an average major axis diameter (L) of 10 to 100 nm which satisfy a relationship between the average major axis diameter (L) and a particle SFD represented by the following formula:

Particle SFD≦0.0001 L²−0.0217 L+1.75 (Invention 1).

Also, according to the present invention, there is provided the ferromagnetic metal particles according to Invention 1, wherein a geometrical standard deviation value of major axis diameters of the particles is not more than 1.80 (Invention 2).

Also, according to the present invention, there is provided the ferromagnetic metal particles according to Invention 1, wherein a content of ultrafine particles having a major axis diameter of less than 10 nm is not more than 15% based on the whole particles (Invention 3).

Further, according to the present invention, there is provided a process for producing the ferromagnetic metal particles as defined in Invention 1, comprising the steps of heat-treating goethite particles to obtain hematite particles; and then subjecting the obtained hematite particles to heat reduction, wherein the heat treatment of the goethite particles is conducted in a non-reducing atmosphere at a temperature of 100 to 250° C., and then under the condition that a steam concentration is not less than 90% by volume at a temperature of 300 to 650° C. (Invention 4).

Also, according to the present invention, there is provided the process for producing the ferromagnetic metal particles according to Invention 5, wherein particles obtained by reacting a mixed alkali aqueous solution of an alkali hydrogencarbonate aqueous solution or an alkali carbonate aqueous solution and an alkali hydroxide aqueous solution with a ferrous salt aqueous solution to obtain a water suspension comprising a ferrous-containing precipitate; aging the water suspension comprising the ferrous-containing precipitate in a non-oxidative atmosphere; producing goethite core crystal particles by an oxidizing agent; allowing a goethite layer to be grown on the surface of the respective core crystal particles, followed by washing the resulting particles with water; and then coating the surface of the thus obtained respective goethite particles with an anti-sintering agent, are used as the goethite particles (Invention 5).

Also, according to the present invention, there is provided the process for producing the ferromagnetic metal particles according to Invention 5, wherein an ammonium peroxodisulfate aqueous solution is used as the oxidizing agent (Invention 6).

Also, according to the present invention, there is provided a process for producing the ferromagnetic metal particles as defined in Invention 1, comprising the steps of:

reacting a mixed alkali aqueous solution of an alkali hydrogencarbonate aqueous solution or an alkali carbonate aqueous solution and an alkali hydroxide aqueous solution with a ferrous salt aqueous solution to obtain a water suspension comprising a ferrous-containing precipitate;

aging the water suspension comprising the ferrous-containing precipitate in a non-oxidative atmosphere;

producing goethite core crystal particles by oxidation reaction; and

then passing an oxygen-containing gas through the water suspension comprising the core crystal particles and the ferrous-containing precipitate to allow a goethite layer to be grown on the surface of the respective core crystal particles by oxidation reaction, thereby producing goethite,

wherein upon growth of the goethite layer, an Al compound is intermittently added in at least two divided parts according to a progress of stage of the oxidation reaction; an anti-sintering agent is added to the water suspension comprising the resulting goethite particles to coat the surface of the respective goethite particles with the anti-sintering agent; the goethite particles surface-coated with the anti-sintering agent are subjected to heat-dehydration treatment in a non-reducing atmosphere to obtain hematite particles; and the obtained hematite particles are subjected to heat reduction in a reducing atmosphere to obtain magnetic metal particles comprising iron as a main component (Invention 7).

Also, according to the present invention, there is provided the process for producing the ferromagnetic metal particles according to Invention 7, wherein an amount of the Al compound added as one of the divided parts is not more than 12 atom % in terms of Al based on whole Fe (Invention 8).

Also, according to the present invention, there is provided the process for producing the ferromagnetic metal particles according to Invention 7, wherein upon production of the core crystal particles, a Co compound is added to the water suspension comprising the ferrous-containing precipitate during the aging before initiation of the oxidation reaction, and then the resulting water suspension is subjected to oxidation reaction (Invention 9).

Also, according to the present invention, there is provided the process for producing the ferromagnetic metal particles according to Invention 7, wherein after intermittently adding the Al compound in two or more divided parts according to the progress of stage of the oxidation reaction, the resulting goethite particles are separated by filtration; the goethite particles are washed with water until an electric conductivity of a filtrate obtained from the water-washing reaches not more than 100 μS; and then the anti-sintering agent is added to the water suspension comprising the resulting goethite particles (Invention 10).

Also, according to the present invention, there is provided the process for producing the ferromagnetic metal particles according to Invention 10, wherein the anti-sintering agent is a rare earth compound (Invention 11).

Also, according to the present invention, there is provided the process for producing the ferromagnetic metal particles according to Invention 11, wherein the goethite particles subjected to the heat-dehydration treatment and heat-reduction treatment have a soluble Co content of not more than 20 ppm (Invention 12).

Also, according to the present invention, there is provided the process for producing the ferromagnetic metal particles according to Invention 12, wherein upon growth of the goethite layer, the Al compound is intermittently added in two or more divided parts according to the progress of stage of the oxidation reaction; and then the oxidizing agent is added to a reaction solution at the time at which the oxidation reaction proceeds such that a Fe²⁺ content in the reaction solution reaches not more than 10%, to thereby oxidize residual Fe²⁺ in the reaction solution into Fe³⁺ (Invention 13).

Also, according to the present invention, there is provided the process for producing the ferromagnetic metal particles according to Invention 13, wherein the goethite particles subjected to the heat-dehydration treatment and heat-reduction treatment have a Fe²⁺ content of not more than 1000 ppm (Invention 14).

In addition, according to the present invention, there is provided a magnetic recording medium comprising:

a non-magnetic substrate;

a non-magnetic undercoat layer formed on the non-magnetic substrate which comprises non-magnetic particles and a binder resin; and

a magnetic recording layer formed on the non-magnetic undercoat layer which comprises the ferromagnetic metal particles as defined in Invention 1, and a binder resin (Invention 15).

### DETAILED DESCRIPTION OF THE INVENTION

The present invention is described in detail below.

First, the ferromagnetic metal particles according to the present invention are described.

The average major axis diameter (L) of the ferromagnetic metal particles according to the present invention is 10 to 100 nm, preferably 10 to 90 nm and more preferably 10 to 80 nm. When the average major axis diameter (L) of the ferromagnetic metal particles is less than 10 nm, the ferromagnetic metal particles tend to be rapidly deteriorated in oxidation stability, and the volume of crystal grains thereof tends to be decreased, resulting in unstable crystal magnetization (superparamagnetism). As a result, it may be difficult to obtain the ferromagnetic metal particles having a high coercive force value and a good Switching Field Distribution (SFD). When the average major axis diameter (L) of the ferromagnetic metal particles is more than 100 nm, the resulting particles tend to have a large particle size, so that magnetic recording media obtained by using the particles tend to be deteriorated in surface smoothness and hardly improved in output owing to the poor surface smoothness, and further undesirably undergo not only deterioration in saturation magnetization or coercive force value in a short wavelength region but also increase in particle-based noise.

The geometrical standard deviation value of major axis diameters of the ferromagnetic metal particles according to the present invention is preferably not more than 1.80, more preferably not more than 1.70 and still more preferably not more than 1.60. When the geometrical standard deviation value of major axis diameters of the ferromagnetic metal particles is more than 1.80, the particle size distribution thereof tends to be broadened, and the coercive force value Hc thereof tends to be fluctuated over a wide range, so that the particle switching field distribution SFD thereof also tends to be undesirably broadened.

The particle SFD of the ferromagnetic metal particles according to the present invention is controlled such that the particles satisfy a relationship between the average major axis diameter (L) and the particle SFD which is represented by the following formula:

Particle SFD≦0.0001 L²−0.0217 L+1.75.

When the relationship between the average major axis diameter (L) and the particle SFD of the ferromagnetic metal particles is out of the specified range represented by the above formula, the resulting particles tend to hardly exhibit an excellent particle SFD.

The ferromagnetic metal particles according to the present invention have an acicular shape. The aspect ratio (ratio of average major axis diameter to average minor axis diameter; hereinafter referred to merely as an “aspect ratio”) of the ferromagnetic metal particles according to the present invention is preferably not less than 2.0 and more preferably 2.3 to 8.0. When the aspect ratio of the ferromagnetic metal particles is less than 2.0, it may be difficult to obtain ferromagnetic metal particles having a high coercive force value. The “acicular” shape as used herein means not only literally an acicular shape, but also a spindle shape and a rice grain-like shape.

The geometrical standard deviation value of volume-based particle diameters of dispersed behavior particles of the ferromagnetic metal particles according to the present invention is preferably not more than 2.0, more preferably not more than 1.9 and still more preferably not more than 1.8. When the geometrical standard deviation value is more than 2.0, the resulting particles tend to be deteriorated in dispersibility owing to unevenness of the particle sizes, so that magnetic recording media obtained by using such particles also tend to be deteriorated in surface smoothness.

The average particle diameter of the dispersed behavior particles of the ferromagnetic metal particles according to the present invention is preferably not more than 300 nm, more preferably 5 to 270 nm and still more preferably 10 to 240 nm. When the average particle diameter of the dispersed behavior particles is more than 300 nm, the ferromagnetic metal particles tend to suffer from sintering therebetween during the step for production thereof, so that the magnetic recording media obtained by using such particles also tend to be deteriorated in surface smoothness and hardly improved in output owing to the poor surface smoothness.

The BET specific surface area value of the ferromagnetic metal particles according to the present invention is preferably 35 to 200 m²/g, more preferably 40 to 180 m²/g and still more preferably 50 to 150 m²/g. When the BET specific surface area value of the ferromagnetic metal particles is less than 35 m²/g, the ferromagnetic metal particles tend to suffer from sintering therebetween during the step for production thereof, so that the magnetic recording media obtained by using such particles also tend to be deteriorated in surface smoothness and hardly improved in output owing to the poor surface smoothness. When the BET specific surface area value of the ferromagnetic metal particles is more than 200 m²/g, the ferromagnetic metal particles tend to have an excessively large surface area and, therefore, tend to be hardly wetted with a binder in a magnetic coating material, resulting in excessively high viscosity of the obtained magnetic coating material. As a result, it may be difficult to well disperse the particles in the magnetic coating material, thereby causing undesirable aggregation of the particles.

As to the content of ultrafine particles present in the ferromagnetic metal particles according to the present invention, the content of the ultrafine particles having a major axis diameter of less than 10 nm in the ferromagnetic metal particles is preferably not more than 15%, more preferably not more than 12% and still more preferably not more than 10% based on the whole particles. In addition, the content of the ultrafine particles having a major axis diameter of not more than 5 nm in the ferromagnetic metal particles is preferably not more than 6%, more preferably not more than 5% and still more preferably not more than 4% based on the whole particles. When the content of the ultrafine particles having a major axis diameter of less than 10 nm which are present in the ferromagnetic metal particles is more than 15% based on the whole particles, the resulting particles tend to be considerably fluctuated in coercive force value Hc owing to the excessively large content of the ultrafine particles, so that the particle switching field distribution SFD thereof also tends to be undesirably broadened.

The ferromagnetic metal particles according to the present invention has a cobalt content of preferably 4 to 60 atom %, more preferably 5 to 55 atom % and still more preferably 10 to 50 atom % in terms of Co based on the whole Fe. By controlling the cobalt content in the ferromagnetic metal particles to the above-specified range, it is possible to obtain the ferromagnetic metal particles having the below-mentioned magnetic properties (coercive force value and saturation magnetization value).

The ferromagnetic metal particles according to the present invention has an aluminum content of preferably 4 to 40 atom %, more preferably 5 to 35 atom % and still more preferably 6 to 30 atom % in terms of Al based on the whole Fe. When the aluminum content in the ferromagnetic metal particles is less than 4 atom %, the particles tend to be deteriorated in anti-sintering effect during the heat-dehydration and heat-reduction steps, resulting in deterioration in coercive force value of the obtained particles. When the aluminum content in the ferromagnetic metal particles is more than 40 atom %, the resulting particles tend to be undesirably deteriorated in magnetic properties owing to increase in amount of non-magnetic components therein.

The ferromagnetic metal particles according to the present invention has a rare earth element content of preferably 3 to 30 atom %, more preferably 4 to 29 atom % and still more preferably 5 to 28 atom % in terms of rare earth element based on the whole Fe. When the rare earth element content in the ferromagnetic metal particles is less than 3 atom %, the particles tend to be deteriorated in anti-sintering effect during the heat-reduction step, resulting in deterioration in coercive force value of the obtained particles. When the rare earth element content in the ferromagnetic metal particles is more than 30 atom %, the resulting particles tend to be undesirably deteriorated in magnetic properties owing to increase in amount of non-magnetic components therein. Meanwhile, in the present invention, Sc and Y are also regarded as the rare earth element.

The ferromagnetic metal particles according to the present invention has a coercive force value Hc of preferably 79.6 to 278.5 kA/m, more preferably 95.4 to 278.5 kA/m and still more preferably 119.4 to 278.5 kA/m. When the coercive force value Hc of the ferromagnetic metal particles is out of the above-specified range, the resulting particles tend to fail to exhibit a high output in a short wavelength region, so that it may be difficult to improve a recording density of the magnetic recording media obtained by using the particles.

The ferromagnetic metal particles according to the present invention has a saturation magnetization value σs of preferably 50 to 180 μm²/kg, more preferably 60 to 170 μm²/kg and still more preferably 70 to 160 μm²/kg. When the saturation magnetization value σs of the ferromagnetic metal particles is less than 50 μm²/kg, the residual magnetization value of the obtained particles also tends to be lowered, so that the resulting particles tend to fail to exhibit a high output in a short wavelength region. When the saturation magnetization value σs of the ferromagnetic metal particles is more than 180 μm²/kg, the resulting particles tend to suffer from excessive residual magnetization, and the magneto-resistance head tends to be saturated, so that the reproduction characteristics of the head tend to suffer from distortion. As a result, the resulting particles tend to fail to exhibit a high C/N output in a short wavelength region.

Next, the process for producing the ferromagnetic metal particles according to the present invention is described. The production process is generally classified into the following three kinds of methods by which the ferromagnetic metal particles according to the present invention can be produced.

### <Method 1>

In the method 1, goethite particles are heat-treated in a non-reducing atmosphere at a temperature of 100 to 250° C., and then subjected to heat-dehydration treatment in an atmosphere comprising steam in an amount of not less than 90% by volume at a temperature of 300 to 650° C. to obtain hematite particles, and further the thus obtained hematite particles are heat-reduced at a temperature of 300 to 700° C., thereby obtaining the ferromagnetic metal particles.

The spindle-shaped goethite particles used in the method 1 may be produced by conventionally known methods.

In the method 1, the goethite particles produced by the following method are preferably used. That is, the goethite particles may be obtained by reacting a mixed alkali aqueous solution of an alkali hydrogencarbonate aqueous solution or an alkali carbonate aqueous solution and an alkali hydroxide aqueous solution with a ferrous salt aqueous solution to obtain a water suspension comprising a ferrous-containing precipitate; aging the water suspension comprising the ferrous-containing precipitate in a non-oxidative atmosphere; producing goethite core crystal particles by subjecting the water suspension to oxidation reaction allowing a goethite layer to be grown on the surface of the respective core crystal particles, followed by washing the resulting particles with water; and then coating the surface of the thus obtained respective goethite particles with an anti-sintering agent.

The goethite core crystal particles may be obtained by adding a Co compound to the water suspension comprising the ferrous-containing precipitate which is obtained by reacting the mixed alkali aqueous solution of an alkali hydrogencarbonate aqueous solution or an alkali carbonate aqueous solution and an alkali hydroxide aqueous solution with the ferrous salt aqueous solution; aging the water suspension in a non-oxidative atmosphere; and then subjecting the water suspension to oxidation reaction by an ordinary method. The oxidation reaction may be carried out, for example, by adding an oxidizing agent to the water suspension. Alternatively, the oxidation reaction may also be carried out by passing an oxygen-containing gas through the water suspension, etc. In particular, in the present invention, the goethite core crystal particles are preferably produced by the method of adding the oxidizing agent to the water suspension.

Examples of the oxidizing agent include ammonium peroxodisulfate and hydrogen peroxide. Among these oxidizing agents, in view of uniformity of the resulting goethite particles, ammonium peroxodisulfate is preferred.

The amount of the oxidizing agent added may be controlled such that Fe²⁺ is oxidized in an amount of preferably 1 to 20%, more preferably 1.5 to 16% and still more preferably 2 to 12% based on the whole Fe²⁺. When the amount of the oxidizing agent added is too small, formation of core crystals of the particles tends to be uneven, so that the particles tend to suffer from non-uniform growth owing to increase in amount of residual growing components, thereby failing to obtain uniform particles having a good particle size distribution.

Meanwhile, the oxidation percentage of Fe²⁺ in the respective steps of the method 1 may be measured by dissolving a part of the reaction solution in a mixed acid (phosphoric acid:sulfuric acid=2:1), adding sodium diphenylaminesulfonate as an indicator to the resulting solution, and then subjecting the obtained mixture to titration using potassium bichromate.

In the production reaction of the goethite core crystal particles, as the ferrous salt aqueous solution, there may be used a ferrous sulfate aqueous solution and a ferrous chloride aqueous solution.

In the production reaction of the goethite core crystal particles, as the Co compound, there may be used cobalt sulfate, cobalt acetate, cobalt chloride and cobalt nitrate. These Co compounds may be used alone or in the form of a mixture of any two or more thereof. The amount of the Co compound added is preferably 4 to 60 atom %, more preferably 5 to 55 atom % and still more preferably 10 to 50 atom % in terms of Co based on the whole Fe in the goethite particles.

After producing the goethite core crystal particles, an Al compound is added to a water suspension comprising the goethite core crystal particles, and an oxygen-containing gas is passed through the water suspension to grow a goethite layer on the surface of the respective core crystal particles, thereby obtaining the goethite particles.

Examples of the Al compound used in the growth reaction of the goethite layer include aluminum salts such as aluminum sulfate, aluminum chloride and aluminum nitrate; and aluminates such as sodium aluminate, potassium aluminate and ammonium aluminate. These Al compounds may be used alone or in the form of a mixture of any two or more thereof, if required. The amount of the Al compound added is preferably 4 to 40 atom %, more preferably 5 to 35 atom % and still more preferably 6 to 30 atom % in terms of Al based on the whole Fe in the goethite particles.

The conditions of Co, Al or rare earth elements such as Y which are present in the goethite particles are not particularly limited. These elements may be uniformly or locally present within the particles and/or on the surface thereof.

The thus produced goethite particles are separated by filtration, and then preferably washed with water until an electric conductivity of a filtrate obtained from the water-washing reaches not more than 100 μS. At this time, if required, the goethite particles before the water-washing may be previously washed with an alkali aqueous solution such as aqueous ammonia and a sodium carbonate aqueous solution. By previously washing the goethite particles with the alkali aqueous solution, the obtained ferromagnetic metal particles can be reduced in amount of sulfuric acid radicals therein.

Next, an anti-sintering agent is added to the water suspension comprising the goethite particles after the water-washing to coat the surface of the respective goethite particles with the anti-sintering agent. The coating treatment with the anti-sintering agent may be carried out according to an ordinary method, i.e., by adding the anti-sintering agent to the water suspension comprising the goethite particles, mixing and stirring the obtained mixture to form a uniform suspension, and then adjusting the pH of the suspension to an adequate pH value such that the surface of the respective goethite particles can be well coated with the anti-sintering agent. Thereafter, the goethite particles whose surface is coated with the anti-sintering agent are separated by filtration, washed with water and then dried, thereby producing the goethite particles as a starting material for the ferromagnetic metal particles.

Examples of the anti-sintering agent include Co compounds; rare earth compounds; phosphorus compounds such as sodium hexametaphosphate, polyphosphoric acid and orthophosphoric acid; silicon compounds such as water glass #3, sodium orthosilicate, sodium metasilicate and colloidal silica; boron compounds such as boric acid; aluminum compounds such as alumina sol and aluminum hydroxide; and titanium compounds such as titanium oxysulfate. These compounds may be used alone or in combination of any two or more thereof. In view of a good anti-sintering effect and good magnetic properties of the resulting ferromagnetic metal particles, among these anti-sintering agents, preferred are Co compounds and rare earth compounds, and more preferred are rare earth compounds.

Meanwhile, as the rare earth compound, there may be suitably used compounds comprising an element selected from the group consisting of scandium, yttrium, lanthanum, cerium, praseodymium, neodymium and samarium. These compounds may be used in the form of a sulfate, a chloride, a nitrate, etc., of the rare earth elements.

The coating amount of the anti-sintering agent is as follows. The coating amounts of Co and Al may be adjusted to fall within the same atom % range as described above with respect to their contents in terms of the respective elements based on the whole Fe in the goethite particles.

The content of the rare earth element(s) is preferably 3 to 30 atom %, more preferably 4 to 29 atom % and still more preferably 5 to 28 atom % in terms of the respective rare earth elements based on the whole Fe in the goethite particles. When the content of the rare earth element is less than 3 atom %, the anti-sintering effect in the heat-reduction step tends to be deteriorated, resulting in lowered coercive force value of the obtained particles. When the content of the rare earth element is more than 30 atom %, the resulting particles tend to be deteriorated in magnetic properties owing to increase in non-magnetic components therein, and the temperature required for the heat reduction tends to be considerably increased, resulting in industrially disadvantageous process. In addition, with respect to the other elements, the content thereof is preferably 0.1 to 20 atom %, more preferably 0.2 to 15 atom % and still more preferably 0.3 to 10 atom % in terms of the respective elements based on the whole Fe in the goethite particles.

The goethite particles as a starting material for production of the ferromagnetic metal particles as used in the method 1 have an average major axis diameter of 10 to 180 nm and preferably 15 to 150 nm. The content of cobalt in the goethite particles is 4 to 60 atom % in terms of Co based on the whole Fe; the content of aluminum therein is 4 to 40 atom % in terms of Al based on the whole Fe; and the content of the rare earth element(s) therein is 3 to 30 atom % in terms of rare earth element(s) based on the whole Fe. In addition, the content of the other elements is 0.1 to 20 atom % in terms of the respective elements based on the whole Fe in the goethite particles.

The heat treatment of the goethite particles in the method 1 is conducted in a non-reducing atmosphere at a temperature of 100 to 250° C. When the temperature of the first heat treatment is less than 100° C., it may be difficult to sufficiently absorb the ultrafine goethite particles into the goethite particles. Whereas, when the heat treatment temperature is more than 250° C., dehydration of the goethite particles tend to be initiated under the condition that the ultrafine goethite particles are still present in the system, so that sintering between the particles tends to be caused. As a result, it may be difficult to obtain the particles having a uniform particle size. The heat treatment temperature of the goethite particles in the method 1 is preferably 120 to 230° C., and the heat treatment time in the method 1 is preferably 5 to 60 min.

The temperature of the heat-dehydration treatment in the method 1 is 300 to 650° C. When the temperature of the heat-dehydration treatment is less than 300° C., the resulting hematite particles tend to have a large number of dehydrated pores within the particles and on the surface thereof. As a result, the ferromagnetic metal particles obtained by heat-reducing the hematite particles tend to be insufficient in dispersibility upon production of magnetic recording media, so that it may be difficult to reduce a surface noise of the obtained magnetic recording media. Whereas, when the temperature of the heat-dehydration treatment is more than 650° C., sintering within the respective particles or between the particles tend to be caused, and the resulting sintered particles tend to be increased in particle diameter, so that it may be difficult to reduce a particle-based noise of the resulting magnetic recording media. The temperature of the heat-dehydration treatment in the method 1 is preferably 350 to 600° C., and the heat treatment time in the method 1 is preferably 5 to 180 min.

The heat-dehydration treatment of the method 1 is conducted in an atmosphere comprising steam in an amount of not less than 90% by volume. When the content of steam in the atmosphere is controlled to not less than 90% by volume, it is possible to effectively reduce the number of dehydrated pores within or on the surface of the resulting hematite particles. The content of steam in the atmosphere for the heat-dehydration treatment is preferably not less than 95% by volume.

Next, the hematite particles are subjected to heat-reduction treatment.

In the method 1, the heat-reduction treatment is preferably conducted in the temperature range of 300 to 700° C. When the heat-reducing temperature is less than 300° C., the reduction reaction tends to proceed too slowly, resulting in undesirably prolonged reaction time. Further, since crystal growth of the ferromagnetic metal particles is insufficient, the resulting particles tend to be considerably deteriorated in magnetic properties such as saturation magnetization and coercive force. When the heat-reducing temperature is more than 700° C., the reduction reaction tends to proceed too rapidly, thereby undesirably causing deformation of the particles as well as sintering within or between the particles. The heat-reduction treatment may be in the form of multi-stage heat-reduction treatment including 1st stage, 2nd stage and, if required, 3rd or more stages which are respectively conducted at different temperatures from each other.

Examples of a reducing gas usable in the heat-reduction treatment of the method 1 include hydrogen, acetylene and carbon monoxide. Among these gases, preferred is hydrogen.

The ferromagnetic metal particles which are obtained after the heat-reduction treatment of the method 1 may be taken out in air by subjecting the particles to surface oxidation treatment by known methods. Specific examples of the surface oxidation treatment include the method of immersing the particles in an organic solvent such as toluene, the method of temporarily replacing the atmosphere existing around the ferromagnetic metal particle obtained after the reduction reaction, with an inert gas, and then gradually increasing an oxygen content in the inert gas until it finally becomes air, the method of gradually oxidizing the particles using a mixed gas of oxygen and steam, or the like.

Among the above methods, in the method 1, there is preferably used the method of temporarily replacing the atmosphere existing around the ferromagnetic metal particle obtained after the reduction reaction, with an inert gas, and then gradually increasing an oxygen content in the inert gas until it finally becomes air, and the method of gradually oxidizing the particles using a mixed gas of oxygen and steam. The treating temperature used in the surface oxidation treatment is 40 to 200° C. and preferably 40 to 180° C. When the treating temperature used in the surface oxidation treatment is less than 40° C., it may be difficult to form a surface oxidation layer having a sufficient thickness. When the treating temperature used in the surface oxidation treatment is more than 200° C., the obtained surface oxidation layer tends to be too thick, so that the resulting particles tend to be deteriorated in magnetic properties. Further, the resulting particles tend to suffer from change in shape of the particles, in particular, tend to be extremely swelled in the minor axis direction owing to production of a large amount of oxide, which is likely to induce destruction of shape of the particles.

### <Method 2>

In the method 2, when adding the Al compound upon the production reaction of the goethite particles, the Al compound is intermittently added in two or more divided parts according to the progress of stage of the oxidation reaction, and the resulting goethite particles are subjected to heat-dehydration treatment to obtain hematite particles, followed by heat-reducing the hematite particles.

In the method 2, the goethite particles are obtained by first producing goethite core crystal particles; growing a goethite layer on the core crystal particles, followed by washing the resulting particles with water; and then coating the surface of the thus obtained goethite particles with an anti-sintering agent.

The goethite core crystal particles are obtained by reacting a mixed alkali aqueous solution of an alkali hydrogencarbonate aqueous solution or an alkali carbonate aqueous solution and an alkali hydroxide aqueous solution with a ferrous salt aqueous solution to obtain a water suspension comprising a ferrous-containing precipitate; aging the water suspension comprising the ferrous-containing precipitate in a non-oxidative atmosphere; and then subjecting the resulting particles to oxidation reaction to thereby produce the goethite core crystal particles, wherein before initiation of the oxidation reaction, a Co compound is added to the water suspension comprising the ferrous-containing precipitate during aging thereof.

Meanwhile, the oxidation reaction may be performed by an ordinary method, for example, by the method of adding an oxidizing agent to the water suspension, the method of passing an oxygen-containing gas through the water suspension, or the like. Examples of the oxidizing agent usable in the oxidation reaction include ammonium peroxodisulfate and hydrogen peroxide.

As the ferrous salt aqueous solution used in the production reaction of the goethite core crystal particles, there may be used a ferrous sulfate aqueous solution, a ferrous chloride aqueous solution, etc.

As the Co compound used in the production reaction of the goethite core crystal particles, there may be used cobalt sulfate, cobalt acetate, cobalt chloride, cobalt nitrate, etc. These compounds may be used alone or in the form of a mixture of any two or more thereof. The amount of the Co compound added is preferably 4 to 50 atom %, more preferably 5 to 45 atom % and still more preferably 10 to 40 atom % in terms of Co based on whole Fe in the goethite particles.

The growth reaction of the goethite layer is conducted by passing an oxygen-containing gas through the water suspension comprising the goethite core crystal particles and the ferrous-containing precipitate to grow the goethite layer on the surface of the core crystal particles by oxidation reaction, wherein the Al compound is intermittently added in two or more divided parts according to the progress of stage of the oxidation reaction. By intermittently adding the Al compound in the divided parts, the amount of Co eluted out from the goethite particles can be reduced, thereby suppressing occurrence of sintering between the particles in the heat-dehydration and heat-reduction treatments. When the Al compound is added at one time or added gradually (i.e., continuously added for a predetermined period of time), the resulting goethite particles tend to suffer from breaking of their shape and, therefore, exhibit a broader particle size distribution and undergo production of ultrafine particles, so that it may be difficult to attain high magnetic properties.

Examples of the Al compound added in the growth reaction of the goethite layer includes aluminum salts such as aluminum sulfate, aluminum chloride and aluminum nitrate, and aluminates such as sodium aluminate, potassium aluminate and ammonium aluminate. These Al compounds may be used alone or in the form of a mixture of any two or more thereof, if necessary. The amount of the Al compound added is preferably 4 to 40 atom %, more preferably 5 to 35 atom % and still more preferably 6 to 30 atom % in terms of Al based on the whole Fe in the goethite particles. When the amount of the Al compound added is controlled to the above-specified range, a sufficient anti-sintering effect can be attained. When the amount of the Al compound added is more than 40 atom % in terms of Al based on the whole Fe in the goethite particles, the amount of non-magnetic components in the resulting particles tends to be comparatively increased, so that magnetic properties of the particles tend to be deteriorated, and the temperature required for the heat-reduction treatment tends to become considerably high, resulting in industrially disadvantageous process.

The Al compound is preferably added during the time period in which the oxidation percentage of Fe²⁺ lies in the range of 20 to 90%, more preferably 25 to 85% and still more preferably 30 to 80%. The Al compound is intermittently added in at least two divided parts in which the amount of the Al compound added as the first part is preferably 1 to 12 atom %, more preferably 1 to 11 atom % and still more preferably 1 to 10 atom % in terms of Al based on the whole Fe in the goethite particles. When the amount of the Al compound added as the first part is more than 14 atom %, the resulting goethite particles are likely to be broken and, therefore, tend to exhibit a broader particle size distribution and undergo production of ultrafine particles, so that it may be difficult to attain high magnetic properties.

It is preferred that the thus produced goethite particles be separated by filtration and then washed with water until an electric conductivity of a filtrate obtained from the water-washing reaches not more than 100 μS. At this time, if required, the goethite particles before the water-washing may be previously washed with an alkali aqueous solution such as aqueous ammonia and a sodium carbonate aqueous solution. By previously washing the goethite particles with the alkali aqueous solution, the obtained ferromagnetic metal particles can be reduced in amount of sulfuric acid radicals therein.

Next, an anti-sintering agent is added to the water suspension comprising the goethite particles after the water-washing to coat the surface of the respective goethite particles with the anti-sintering agent. The coating treatment with the anti-sintering agent may be carried out by the same method as described in the method 1. The kind of anti-sintering agent used, the coating amount of the anti-sintering agent and kinds of elements formulated therein all are the same as those described in the above method 1.

The goethite particles as a starting material for production of the ferromagnetic metal particles according to the method 2 have an average major axis diameter of 10 to 180 nm and preferably 15 to 150 nm, an aspect ratio of 3 to 10 and preferably 4 to 9, and a BET specific surface area value of 100 to 300 m²/g and preferably 110 to 280 m²/g. The content of cobalt in the goethite particles is 4 to 50 atom % in terms of Co based on the whole Fe; the content of aluminum therein is 4 to 40 atom % in terms of Al based on the whole Fe; and the content of the rare earth element(s) therein is 3 to 30 atom % in terms of rare earth element(s) based on the whole Fe. In addition, the content of the other elements is 0.1 to 20 atom % in terms of the respective elements based on the whole Fe in the goethite particles.

### <Method 3>

In the method 3, the goethite particles having a soluble Co content of not more than 20 ppm are subjected to heat-dehydration treatment to obtain hematite particles, and then the thus obtained hematite particles are heat-reduced.

The goethite particles having a soluble Co content of not more than 20 ppm are obtained by first producing goethite core crystal particles; growing a goethite layer on the core crystal particles, followed by washing the resulting particles with water; and coating the surface of the thus obtained goethite particles with a rare earth compound.

The goethite core crystal particles are obtained by reacting a mixed alkali aqueous solution of an alkali hydrogencarbonate aqueous solution or an alkali carbonate aqueous solution and an alkali hydroxide aqueous solution with a ferrous salt aqueous solution to obtain a water suspension comprising a ferrous-containing precipitate; aging the water suspension comprising the ferrous-containing precipitate in a non-oxidative atmosphere; and then subjecting the resulting particles to oxidation reaction to thereby produce the goethite core crystal particles, wherein before initiation of the oxidation reaction, a Co compound is added to the water suspension comprising the ferrous-containing precipitate during the aging thereof.

Meanwhile, the oxidation reaction may be performed by an ordinary method, for example, by the method of adding an oxidizing agent to the water suspension, the method of passing an oxygen-containing gas through the water suspension, or the like. Examples of the oxidizing agent include ammonium peroxodisulfate and hydrogen peroxide.

It is important that the Co compound is added upon the production reaction of the goethite core crystal particles. If the Co compound is added at the other stages, for example, upon the growth reaction of the goethite layer or upon the coating treatment of the surface layer portion of the goethite particle for the purpose of attaining the anti-sintering effect, the amount of the soluble Co eluted out from the goethite particles tends to be increased, so that sintering between the particles upon the heat-dehydration and heat-reduction treatments tends to readily occur.

In the production reaction of the goethite core crystal particles, the kinds and amounts of the ferrous salt aqueous solution and Co compound added may be the same as those used in the method 2.

The growth reaction of the goethite layer is conducted by passing an oxygen-containing gas through the water suspension comprising the goethite core crystal particles and the ferrous-containing precipitate to grow the goethite layer on the surface of the core crystal particles by oxidation reaction, wherein the Al compound is intermittently added in two or more divided parts according to the progress of stage of the oxidation reaction. By intermittently adding the Al compound in the divided parts, the amount of Co eluted out from the goethite particles can be reduced, thereby suppressing occurrence of sintering between the particles in the heat-dehydration and heat-reduction treatments. When the Al compound is added at one time or added gradually (i.e., continuously added for a predetermined period of time), it may be difficult to reduce the amount of Co eluted out from the goethite particles, and further the resulting goethite particles tend to suffer from breaking of their shape, thereby failing to attain high magnetic properties.

In the growth reaction of the goethite layer, the kind and amount of the Al compound added and the addition time thereof are the same as those described in the method 2.

Also, in the method 3, after intermittently adding the Al compound in divided parts, an oxidizing agent may be added, if required, to the reaction solution at the time at which the oxidation reaction proceeds until a Fe²⁺ content in the reaction solution reaches less than 10%, to thereby forcibly oxidize residual Fe²⁺ in the reaction solution into Fe³⁺. By converting the residual Fe²⁺ in the reaction solution into Fe³⁺, the resulting ferromagnetic metal particles can be further enhanced in magnetic properties. In addition, since the amount of Co eluted out from the goethite particles is reduced, the sintering between the particles upon the heat-dehydration and heat-reduction treatments can be suppressed.

As the oxidizing agent used in the oxidation reaction after intermittently adding the Al compound in divided parts, there may be used ammonium peroxodisulfate and hydrogen peroxide which are used in the above production reaction of the goethite core crystal particles.

It is preferred that the thus produced goethite particles be separated by filtration and then washed with water until an electric conductivity of a filtrate obtained from the water-washing reaches not more than 100 μS. At this time, if required, the goethite particles before the water-washing may be previously washed with an alkali aqueous solution such as aqueous ammonia and a sodium carbonate aqueous solution. By previously washing the goethite particles with the alkali aqueous solution, the obtained ferromagnetic metal particles can be reduced in amount of sulfuric acid radicals therein.

Next, a rare earth compound as an anti-sintering agent is added to the water suspension comprising the goethite particles after the water-washing to coat the surface of the respective goethite particles with the rare earth compound. The coating treatment with the rare earth compound may be carried out according to an ordinary method, i.e., by adding the rare earth compound to the water suspension comprising the goethite particles, mixing and stirring the obtained mixture to form a uniform suspension, and further adjusting the pH of the suspension to an adequate pH value such that the surface of the respective goethite particles can be well coated with the rare earth compound. Thereafter, the goethite particles whose surface is coated with the rare earth compound are separated by filtration, washed with water and then dried, thereby producing the goethite particles as a starting material for the ferromagnetic metal particles according to the present invention.

As the rate earth compound to be added, there may be suitably used compounds of one or more rare earth elements selected from the group consisting of scandium, yttrium, lanthanum, cerium, praseodymium, neodymium and samarium. The rare earth compound may be in the form of a sulfate, a chloride, a nitrate. etc., of these rare earth elements. The content of the rare earth compound is preferably 3 to 30 atom %, more preferably 4 to 29 atom % and still more preferably 5 to 28 atom % in terms of rare earth element based on the whole Fe in the goethite particles. When the content of the rare earth compound is less than 3 atom %, the anti-sintering effect in the heat-reduction step tends to be deteriorated, resulting in undesirable decrease in coercive force value of the obtained ferromagnetic metal particles. When the content of the rare earth compound is more than 30 atom %, the resulting particles tend to be deteriorated in magnetic properties owing to increase in content of non-magnetic components therein, and the temperature required for the heat-reduction treatment tends to be considerably increased, resulting in industrially disadvantageous process.

Meanwhile, in any of the methods 1, 2 and 3, for the purpose of improving magnetic properties of the resulting particles as well as a dispersibility thereof in a magnetic coating material, the elements other than those described above, for example, such as Si, Mg, Zn, Cu, Ti, Ni and P may be added to the particles.

The goethite particles as a starting material for production of the ferromagnetic metal particles according to the method 3 have an average major axis diameter of 10 to 180 nm and preferably 10 to 150 nm, an aspect ratio of 3 to 10 and preferably 4 to 9, a BET specific surface area value of 100 to 300 m²/g and preferably 110 to 280 m²/g, a soluble Co content of not more than 20 ppm and preferably not more than 15 ppm, a soluble Al content of not more than 10 ppm, and a soluble rare earth element content of not more than 5 ppm. Also, the content of cobalt in the goethite particles is 4 to 50 atom % in terms of Co based on the whole Fe; the content of aluminum therein is 4 to 40 atom % in terms of Al based on the whole Fe; and the content of the rare earth element(s) therein is 3 to 30 atom % in terms of rare earth element(s) based on the whole Fe. In addition, the content of the other elements is 0.1 to 20 atom % in terms of the respective elements based on the whole Fe in the goethite particles.

In the case where the soluble Co is present in the goethite particles, the sintering between the particles upon the heat-dehydration and heat-reduction treatments tends to occur. Therefore, when the goethite particles having a soluble Co content of more than 20 ppm are used as a starting material for the ferromagnetic metal particles, the obtained ferromagnetic metal particles tend to suffer from sintering between the particles, so that it may be difficult to attain a good dispersibility thereof upon production of the magnetic coating material.

The goethite particles as the starting material for producing the ferromagnetic metal particles according to the method 3 preferably have a residual Fe²⁺ content of not more than 1000 ppm, more preferably not more than 500 ppm and still more preferably not more than 100 ppm. When controlling the residual Fe²⁺ content to not more than 1000 ppm, the soluble Co content in the goethite particles can be reduced, and the ferromagnetic metal particles obtained by using the goethite particles can be enhanced in magnetic properties.

Next, the goethite particles obtained in the methods 2 and 3 are subjected to heat-dehydration treatment in a non-oxidative atmosphere to obtain hematite particles.

As the non-oxidative atmosphere, there may be used a flow of at least one gas selected from the group consisting of air, an oxygen gas and a nitrogen gas. Also, the non-oxidative atmosphere may comprise steam, etc.

The heat-dehydration treatment may be conducted in a temperature range of 100 to 650° C. When the heat-dehydrating temperature is less than 100° C., the heat-dehydration treatment tends to be prolonged. When the heat-dehydrating temperature is more than 650° C., deformation of the particles and sintering within or between the particles tend to be undesirably caused. Also, the heat-dehydration treatment may be performed in the form of multi-stage heat-dehydration treatment including the first and second stages which are different in temperature used therein from each other.

Next, the hematite particles are subjected to heat-reduction treatment. The conditions of the heat-reduction treatment as well as the surface oxidation treatment after the heat-reduction treatment used in the methods 2 and 3 all may be the same as those described in the above method 1.

Next, the magnetic recording medium of the present invention is described. In the magnetic recording medium of the present invention, the above ferromagnetic metal particles are used.

The magnetic recording medium of the present invention comprises a non-magnetic substrate, a non-magnetic undercoat layer formed on the non-magnetic substrate, and a magnetic recording layer formed on the non-magnetic undercoat layer. Also, if required, a back coat layer may be formed on the surface of the non-magnetic substrate which is opposite to its surface where the magnetic recording layer is provided. In particular, in the case of backup recording tapes for computers, from the viewpoints of preventing occurrence of uneven winding and enhancing a running durability, it is preferable to form the back coat layer.

In the present invention, as the non-magnetic substrate, there may be used films of synthetic resins, e.g., polyesters such as polyethylene terephthalate and polyethylene naphthalate, polyolefins such as polyethylene and polypropylene, polycarbonates, polyamides, polyamide imides, polyimides, aromatic polyamides, aromatic polyimides, aromatic polyamide imides, polysulfones, cellulose triacetate and polybenzoxazole; foils and plates of metals such as aluminum and stainless steel, and various papers, which are generally used for production of magnetic recording media at the present time.

The non-magnetic undercoat layer used in the present invention comprises non-magnetic particles and a binder resin. In addition, the non-magnetic undercoat layer may also comprise, if required, a lubricant, an abrasive, an antistatic agent, etc., which are ordinarily used for production of magnetic recording media.

As the non-magnetic particles for the non-magnetic undercoat layer, there may be used particles of alumina, hematite, goethite, titanium oxide, silica, chromium oxide, cerium oxide, zinc oxide, silicon nitride, boron nitride, silicon carbide, calcium carbonate and barium sulfate. These non-magnetic particles may be used alone or in combination of any two or more thereof. Among these non-magnetic particles, particles of hematite, goethite and titanium oxide are preferred, and hematite is more preferred.

The non-magnetic particles may be of any shape such as an acicular shape, a spindle shape, a rice grain-like shape, a spherical shape, a granular shape, a polyhedral shape, a flake-like shape, a scale-like shape and a plate shape. The non-magnetic particles preferably have a particle size of 0.005 to 0.30 μm and more preferably 0.010 to 0.25 μm. Also, the surface of the non-magnetic particles may be coated, if required, with one or more compounds selected from the group consisting of hydroxides of aluminum, oxides of aluminum, hydroxides of silicon and oxides of silicon. The thus coated non-magnetic particles can be enhanced in dispersibility in a non-magnetic coating material as compared to the uncoated particles.

Examples of the binder resin include those which are generally used for production of magnetic recording media at the present time, such as thermoplastic resins, thermosetting resins and electron beam-curable resins. These binder resins may be used alone or in combination of any two or more thereof.

Examples of the antistatic agent include conductive particles such as carbon black, graphite, tin oxide and titanium oxide/tin oxide/antimony oxide, as well as surfactants. Among these antistatic agents, carbon black is preferably used because it is expected to attain not only the antistatic effect but also the effects of reduction in frictional coefficient and enhancement in strength of the resulting magnetic recording media.

The magnetic recording layer used in the present invention comprises the ferromagnetic metal particles according to the present invention and a binder resin, and may also comprise, if required, a lubricant, an abrasive, an antistatic agent, etc., which are generally used for production of magnetic recording media.

As the binder resin, there may be used the same binder resins as used for production of the above non-magnetic undercoat layer.

The back coat layer used in the present invention preferably comprises, in addition to a binder resin, an antistatic agent and inorganic particles for the purpose of reducing a surface electric resistance and a light transmittance of the back coat layer and enhancing a strength thereof, and may further comprise, if required, a lubricant, an abrasive, etc., which are generally used for production of magnetic recording media.

As the binder resin and antistatic agent, there may be used the same binder resins and antistatic agents as used for production of the above non-magnetic undercoat layer and magnetic recording layer.

As the inorganic particles, there may be used one or more inorganic particles selected from the group consisting of particles of alumina, hematite, goethite, titanium oxide, silica, chromium oxide, cerium oxide, zinc oxide, silicon nitride, boron nitride, silicon carbide, calcium carbonate and barium sulfate. The inorganic particles preferably have a particle size of 0.005 to 1.0 μm and more preferably 0.010 to 0.5 μm.

The magnetic recording medium of the present invention has a coercive force value of preferably 63.7 to 318.3 kA/m and more preferably 71.6 to 318.3 kA/m; a squareness (Br/Bm) of preferably not less than 0.65 and more preferably not less than 0.70; a switching field distribution SFD of preferably not more than 0.60, more preferably not more than 0.55 and still more preferably not more than 0.50; and a surface roughness Ra of a coating film of preferably not more than 6.0 nm, more preferably not more than 5.5 nm and still more preferably not more than 5.0 nm.

In the process for producing the ferromagnetic metal particles according to the method 1 of the present invention in which the goethite particles are heat-treated to obtain hematite particles and then the resulting hematite particles are heat-reduced, the heat treatment of the goethite particles is carried out in a non-reducing atmosphere in a temperature range of 100 to 250° C. and then under the condition that a steam is present in an amount of not less than 90% by volume in a temperature range of 300 to 650° C., so that the obtained ferromagnetic metal particles have a less content of ultrafine particles and a good particle switching field distribution SFD although they are fine particles, in particular, such fine particles having an average major axis diameter of not more than 100 nm.

The reason why the ferromagnetic metal particles obtained by the above method can exhibit a good particle switching field distribution SFD and a less content of ultrafine particles, considered by the present inventors as follows. That is, by suitably controlling the conditions for the heat treatment of the goethite particles and conducting the heat-dehydration treatment in the presence of steam, the content of fine particles in the goethite particles can be reduced, and the goethite particles can be transformed into hematite particles under the condition that the amount of the fine particles being present in the goethite particles is kept as small as possible, thereby enabling production of the hematite particles having a uniform particle size which are prevented from sintering between the goethite particles. As a result, it is considered that the ferromagnetic metal particles obtained by subsequently subjecting the hematite particles to the heat-reduction treatment can also exhibit a uniform particle size with a less content of ultrafine particles therein, and can be improved in particle switching field distribution SFD.

Further, in the process for producing the ferromagnetic metal particles according to the method 1 of the present invention in which the goethite particles are heat-treated to obtain hematite particles and then the resulting hematite particles are heat-reduced, when particles obtained by reacting a mixed alkali aqueous solution of an alkali hydrogencarbonate aqueous solution or an alkali carbonate aqueous solution and an alkali hydroxide aqueous solution with a ferrous salt aqueous solution to obtain a water suspension comprising a ferrous-containing precipitate; aging the water suspension comprising the ferrous-containing precipitate in a non-oxidative atmosphere; producing goethite core crystal particles by an oxidizing agent; allowing a goethite layer to be grown on the surface of the respective core crystal particles, followed by washing the resulting particles with water; and then coating the surface of the thus obtained respective goethite particles with an anti-sintering agent, are used as the goethite particles to be heat-treated, the resulting ferromagnetic metal particles can exhibit a uniform particle size, a less content of ultrafine particles and a good particle switching field distribution SFD, although they are fine particles, in particular, such fine particles having an average major axis diameter of not more than 100 nm.

The reason why the ferromagnetic metal particles obtained by the above method can exhibit a good particle switching field distribution SFD, a uniform particle size and a less content of ultrafine particles, considered by the present inventors as follows. That is, since under the conditions for production of the goethite particles, the uniform goethite core crystal particles are produced by using the oxidizing agent before the oxidation reaction, the goethite particles subsequently obtained by the growth reaction thereof can also exhibit a less content of ultrafine particles and a good particle size distribution. Therefore, by using the goethite particles as a starting material as well as controlling the conditions for the heat treatment of the goethite particles and conducting the heat-dehydration treatment in the presence of steam, the content of fine particles in the goethite particles can be further reduced. In addition, since the goethite particles are transformed into hematite particles under the condition that the amount of the fine particles being present in the goethite particles is kept as small as possible, it is possible to produce the hematite particles having a uniform particle size which are prevented from sintering between the goethite particles. As a result, it is considered that the ferromagnetic metal particles obtained by subsequently subjecting the hematite particles to the heat-reduction treatment can also exhibit a uniform particle size with a less content of ultrafine particles therein, and can be improved in particle switching field distribution SFD.

In addition, in the process for producing the ferromagnetic metal particles according to the method 2 of the present invention, when the Al compound to be added upon the production reaction of the goethite particles is intermittently added in two or more divided parts according to the progress of stage of the oxidation reaction, the ferromagnetic metal particles obtained by heat-reducing the resulting goethite particles can exhibit a uniform particle size, a less content of ultrafine particles and excellent magnetic properties, although they are fine particles having an average major axis diameter of not more than 100 nm.

The reason why the ferromagnetic metal particles produced by the process of the present invention can exhibit excellent magnetic properties, a uniform particle size and a less content of ultrafine particles, is considered by the present inventors as follows.

That is, according to the present inventors' findings, if the Al compound is added at one time or gradually, for example, upon the growth of the goethite layer, the resulting ferromagnetic metal particles tend to comprise particles which are broken in shape and, therefore, have a non-uniform particle size owing to the presence of a large number of ultrafine particles therein. To solve the problem, the Al compound to be added upon the growth reaction of goethite is intermittently added in two ore more divided parts according to the progress of stage of the oxidation reaction, so that it is possible to obtain the ferromagnetic metal particles capable of exhibiting a less content of ultrafine particles, a uniform particle size and excellent magnetic particles.

Further, in the process for producing the ferromagnetic metal particles according to the method 3 of the present invention, the ferromagnetic metal particles obtained by heat-reducing the goethite particles having a soluble Co content of not more than 20 ppm exhibit an excellent dispersibility, although they are fine particles, in particular, such fine particles having an average major axis diameter of not more than 100 nm.

The reason why the ferromagnetic metal particles exhibit an excellent dispersibility, is considered by the present inventors as follows.

That is, according to the present inventors' findings, when the Co compound is added, for example, upon the growth reaction of goethite or upon the anti-sintering treatment after the growth reaction of goethite, the soluble Co content in the resulting particles tends to be increased. As a result, the ferromagnetic metal particles produced from the thus obtained particles as a precursor may fail to exhibit a high dispersibility owing to generation of a large number of sintered particles therein. To solve the problem, by adding the Co compound upon the production reaction of the goethite core crystal particles, the Co is doped into the goethite core crystal particles to form a solid solution thereof within the goethite particles. Further, since the aluminum compound to be added upon the growth reaction of goethite is intermittently added in two or more divided parts, it is considered that the soluble Co content in the goethite particles can be reduced. In addition, when the particles are washed with water before the anti-sintering treatment to remove the soluble Co therefrom, the soluble Co content can be further reduced. As a result, it is considered that the resulting particles can be prevented from suffering from sintering between the particles upon the subsequent heat-dehydration and heat-reduction steps.

In addition, according to the present inventors' study, it has been found that when converting Fe²⁺ in the goethite particles into Fe³⁺ using an oxidizing agent, the soluble Co content therein can be still further reduced, so that the resulting ferromagnetic metal particles can also be enhanced in magnetic properties.

The ferromagnetic metal particles according to the present invention exhibit a uniform particle size, a less content of ultrafine particles and a good particle switching field distribution SFD, although they are fine particles, in particular, such fine particles having an average major axis diameter of not more than 100 nm and, therefore, are suitable as ferromagnetic metal particles for high-density magnetic recording media.

Also, in the magnetic recording medium of the present invention, since the ferromagnetic metal particles having a uniform particle size and a less content of ultrafine particles and a good particle switching field distribution SFD as described above are used as magnetic particles for magnetic recording media, the resulting magnetic recording medium is suitable as a high-density magnetic recording medium having excellent surface smoothness and switching field distribution SFD.

The ferromagnetic metal particles produced by the process of the present invention exhibit a uniform particle size, a less content of ultrafine particles and excellent magnetic properties, although they are fine particles, in particular, such fine particles having an average major axis diameter of not more than 100 nm and, therefore, are suitable as ferromagnetic metal particles for high-density magnetic recording media.

Further, in the magnetic recording medium of the present invention, since the ferromagnetic metal particles having a uniform particle size and a less content of ultrafine particles as described above are used as magnetic particles for magnetic recording media, the resulting magnetic recording medium can exhibit a good surface smoothness and, therefore, is suitable as a high-density magnetic recording medium.

The ferromagnetic metal particles of the present invention are prevented from aggregation of the particles due to sintering therebetween and exhibit a good dispersibility, although they are fine particles, in particular, such fine particles having an average major axis diameter of not more than 100 nm, and, therefore, are suitable as ferromagnetic metal particles for high-density magnetic recording media.

In addition, the magnetic recording medium of the present invention in which the above ferromagnetic metal particles that are prevented from aggregation of the particles due to sintering therebetween are used as magnetic particles for magnetic recording media, exhibits a good surface smoothness and, therefore, is suitable as a high-density magnetic recording medium.

### EXAMPLES

Typical examples and embodiments of the present invention are as follows. However, the following Examples are only illustrative and not intended to limit the scope of the present invention thereto. The measuring and evaluating methods used in the following Examples, etc., are described below.

The average major axial diameter and average minor axial diameter of the particles in the present invention were respectively expressed by an average value of major axis diameters and minor axis diameters as respectively measured for not less than 350 particles which were selected from those appearing on a micrograph obtained by a transmission electron microscope. The criteria for selection of the particles from the transmission electron micrograph used in the above measurements are as follows.

A: The particles which were overlapped with each other so that a boundary between the particles was unclear were excluded from the measurement.

B: The particles having an average particle diameter of less than 10 nm were excluded from the calculation of average particle diameter (average major axis diameter and average minor axis diameter).

Meanwhile, the average major axis diameter and average minor axis diameter of the ferromagnetic metal particles were measured as follows. That is, 0.04 part by weight of the ferromagnetic metal particles, 0.12 part by weight of a dispersant and 99.84 parts by weight of a dispersing medium (dispersing solvent) were dispersed for 3 min using an ultrasonic disperser, and then the resulting dispersion was passed through a wet-type jet mill 10 times to prepare a dispersion as a sample. The thus prepared sample was used for the above observation using a transmission electron microscope.

Also, the geometrical standard deviation of the major axis diameters of the ferromagnetic metal particles was expressed by the value determined according to the following method. That is, the particle diameters were measured from the magnified micrograph. The actual particle diameters and the number of the particles were calculated from the measured values. On a logarithmic normal probability paper, the particle diameters were plotted at regular intervals on the abscissa-axis, whereas the accumulative number of particles (integration of undersize particles) belonging to each interval of the particle diameters were plotted by percentage on the ordinate-axis by a statistical technique. The particle diameters corresponding to the number of particles of 50% and 84.13%, respectively, were read from the graph, and the geometrical standard deviation was calculated from the following formula:

Geometrical standard deviation={particle diameter corresponding to 84.13% calculated as integration of undersize particles}/{particle diameter(geometrical average diameter)corresponding to 50% calculated as integration of undersize particles}

The closer to 1 the geometrical standard deviation value, the more excellent the particle size distribution.

The content of the fine particles (having a particle diameter of less than 10 nm) being present in the particles to be measured was expressed by a percentage (%) of the number (as calculated) of the particles having a major axis diameter of less than 10 nm relative to (the number of) the whole particles as measured. Also, the content of the fine particles (having a particle diameter of less than 5 nm) was expressed by a percentage (%) of the number of the particles having a major axis diameter of less than 5 nm relative to (the number of) the whole particles measured.

The aspect ratio was expressed by the ratio of the average major axis diameter to the average minor axis diameter.

The specific surface area value of the goethite particles and the ferromagnetic metal particles as used or produced in the present invention was expressed by the value measured by BET method using “Monosorb MS-11” (manufactured by Cantachrom Co., Ltd.).

The contents of Co, Al and rare earth element(s) in the goethite particles and the ferromagnetic metal particles as used or produced in the present invention, were measured using an inductively coupled plasma atomic emission spectroscopic analyzer “SPS4000” (manufactured by Seiko Denshi Kogyo Co., Ltd.).

The soluble Co content, the soluble Al content and the soluble rare earth element content in the goethite particles and the ferromagnetic metal particles as used or produced in the present invention, were determined as follows. That is, 5 g of a sample was weighed and charged in a 300 mL conical flask, and 100 mL of boiling pure water was added into the flask. The contents of the flask were heated and allowed to stand under the boiling state for 5 min, and then the flask was plugged and held until the contents thereof were naturally cooled to ordinary temperatures. After adding to the flask, water in an amount corresponding to loss of water, the flask was plugged again, and the contents thereof were shaken and mixed for 1 min and then allowed to stand for 5 min. The resulting supernatant was filtered using a No. 5C filter paper, and the obtained filtrate was measured using an inductively coupled plasma atomic emission spectroscopic analyzer “SPS4000” (manufactured by Seiko Denshi Kogyo Co., Ltd.).

The average particle diameter of behavior particles of the ferromagnetic metal particles according to the present invention was measured as follows. That is, 0.04 part by weight of the ferromagnetic metal particles, 0.12 part by weight of a dispersant and 99.84 parts by weight of a dispersing medium (dispersing solvent) were dispersed for 3 min using an ultrasonic disperser, and then the resulting dispersion was passed through a wet-type jet mill 10 times to prepare a dispersion. The thus prepared dispersion was measured using a particle size distribution measuring apparatus “FPAR-1000” (manufactured by Otsuka Electronics Co., Ltd.) capable of measuring a particle size distribution of behavior particles in a solution by a dynamic light-scattering method. Meanwhile, a cumulant method was used as the analyzing method.

In addition, the geometrical standard deviation (D_{84.13}/D₅₀) of the behavior particles of the ferromagnetic metal particles according to the present invention was determined as follows. That is, the volume-based particle diameters and the frequency distribution thereof as measured by the above dynamic light-scattering method were plotted on a graph. The particle diameters corresponding to the number of particles of 50% and 84.13%, respectively, were read from the graph, and the geometrical standard deviation was expressed by the value calculated from the following formula:

Geometrical standard deviation={particle diameter corresponding to 84.13% calculated as integration of undersize particles}/{particle diameter(geometrical average diameter)corresponding to 50% calculated as integration of undersize particles}

The closer to 1 the geometrical standard deviation value, the more excellent the particle size distribution of the ferromagnetic metal particles as behavior particles.

The magnetic properties of the ferromagnetic metal particles were measured using a vibration sample magnetometer “VSM-SSM-5-15” (manufactured by Toei Kogyo Co., Ltd.) by applying an external magnetic field of 795.8 kA/m thereto. The particle SFD was measured at a sweep speed of 79.6 (kA/m)/min in the applied magnetic field range of 0 to 397.9 kA/m and at a sweep speed of 397.9 (kA/m)/min in the applied magnetic field range of 397.9 to 1,193.7 kA/m.

The magnetic properties of the magnetic recording medium were measured using a vibration sample magnetometer “Model BHV-35” (manufactured by Riken Electronics Co., Ltd.) by applying an external magnetic field of 795.8 kA/m thereto.

The surface roughness Ra of a coating film of the magnetic recording medium was determined as a centerline average roughness Ra of the coating film as measured using a non-contact surface shape measuring apparatus “Newview 600s” (manufactured by Zygo Co., Ltd.).

### Example 1-1

### Production of Ferromagnetic Metal Particles

### According to Method 1

### <Heat-Dehydration Treatment>

Goethite particles 1 (average major axis diameter: 76.2 nm; Co content (Co/Fe): 39.7 atom %; Al content (Al/Fe): 20.2 atom %; Y content (Y/Fe): 20.4 atom %) were heat-treated at 180° C. in air for 30 min, and then subjected to heat-dehydration treatment for 30 min using overheated steam at 440° C. comprising steam in an amount of 98% by volume, thereby obtaining hematite particles.

### <Heat-Reduction Treatment>

The thus obtained hematite particles were charged in a batch-type fixed bed reducing apparatus, and heat-reduced therein at 550° C. while flowing therethrough a hydrogen gas at a rate of 50 cm/s. Thereafter, the hydrogen gas was replaced with a nitrogen gas, and the particles were cooled to 80° C. The nitrogen gas was mixed with air to gradually increase an oxygen concentration therein to 0.35% by volume, thereby subjecting the particles to surface oxidation treatment to form a surface oxidation layer on the surface of the respective particles.

Next, the ferromagnetic metal particles formed thereon with the surface oxidation layer were heated to 600° C. under a hydrogen gas atmosphere, at which the particles were heat-reduced again while flowing the hydrogen gas at a rate of 60 cm/s. Thereafter, the hydrogen gas was replaced again with a nitrogen gas, and the particles were cooled to 80° C. The nitrogen gas was mixed with steam of 6 g/m³ and air to gradually increase an oxygen concentration therein to 0.35% by volume, whereby the particles were subjected to surface oxidation treatment to form a stable surface oxidation layer on the surface of the respective particles, thereby obtaining ferromagnetic metal particles of Example 1-1.

The resulting ferromagnetic metal particles of Example 1-1 were particles having an acicular shape, an average major axis diameter of 42.2 nm, an aspect ratio of 3.6, and a BET specific surface area value of 76.5 m²/g. The content of fine particles (particles having a major axis diameter of not more than 10 nm) being present in the ferromagnetic metal particles was 7%, and the geometrical standard deviation value of the major axis diameters was 1.49. The content of Co in the ferromagnetic metal particles was 39.9 atom % in terms of Co based on whole Fe; the content of Al therein was 20.1 atom % in terms of Al based on whole Fe; and the content of Y therein was 20.5 atom % in terms of Y element based on whole Fe. In addition, as to the magnetic properties of the ferromagnetic metal particles, the coercive force value Hc thereof was 183.0 kA/m; the saturation magnetization value σs thereof was 104.4 Am²/kg; and the particle SFD thereof was 0.95.

### Example 2-1

### Production of Magnetic Recording Medium

<Non-magnetic undercoat layer composition>

| | |
|---|---|
| Hematite particles (particle shape: spindle shape; | 100.0 parts by weight |
| average major axis diameter: | |
| 0.099 μm; aspect ratio: 6.2; | |
| BET specific surface area value: 59.1 m²/g) | |
| Vinyl chloride-based copolymer resin having a | 11.8 parts by weight |
| potassium sulfonate group | |
| Polyurethane resin having a sodium | 11.8 parts by weight |
| sulfonate group | |
| Cyclohexanone | 78.3 parts by weight |
| Methyl ethyl ketone | 195.8 parts by weight |
| Toluene | 117.5 parts by weight |
| Curing agent (polyisocyanate) | 3.0 parts by weight |
| Lubricant (butyl stearate) | 1.0 part by weight |

<Magnetic recording layer composition>

| | |
|---|---|
| Ferromagnetic metal particles obtained | 100.0 parts by weight |
| in Example 1-1 | |
| Vinyl chloride-based copolymer resin having a | 10.0 parts by weight |
| potassium sulfonate group | |
| Polyurethane resin having a sodium | 10.0 parts by weight |
| sulfonate group | |
| Abrasive (AKP-50) | 10.0 parts by weight |
| Carbon black | 1.0 part by weight |
| Lubricant (myristic acid:butyl stearate = 1:2) | 3.0 parts by weight |
| Curing agent (polyisocyanate) | 5.0 parts by weight |
| Cyclohexanone | 65.8 parts by weight |
| Methyl ethyl ketone | 164.5 parts by weight |
| Toluene | 98.7 parts by weight |

The above non-magnetic undercoat layer composition and magnetic recording layer composition were respectively kneaded using a kneader, and then the resulting kneaded materials were respectively mixed and dispersed using a paint shaker and passed through a filter having an average pore size of 3 μm, thereby obtaining a non-magnetic undercoat layer coating material and a magnetic recording layer coating material.

The thus obtained non-magnetic undercoat layer coating material was applied onto a 4.5 μm-thick aromatic polyamide film and then dried to form a non-magnetic undercoat layer, and successively the above obtained magnetic recording layer coating material was applied onto the thus formed non-magnetic undercoat layer. The resulting coating layer was oriented in a magnetic field and then dried. The resulting coating layer was subjected to calendering treatment and then to curing reaction at 60° C. for 24 hr, and then slit into a width of 12.7 mm, thereby obtaining a magnetic recording medium.

The resulting magnetic recording medium had a coercive force value of 197.6 kA/m; a squareness (Br/Bm) of 0.782; a switching field distribution SFD of 0.526; and a surface roughness Ra of 3.9 nm.

Thus, the ferromagnetic metal particles and the magnetic recording medium were produced according to Example 1-1 and Example 2-1. The production conditions used in these Examples and various properties of the thus obtained ferromagnetic metal particles and the magnetic recording medium are shown in the Tables below.

### Goethite Particles 2 to 5:

As the goethite particles as starting materials, the goethite particles 2 to 5 having various properties as shown in Table 1 were prepared.

TABLE 1

Properties of goethite particles

| | Average | | | |
|---|---|---|---|---|
| Kinds of | major axis | | | |
| goethite | diameter | Co content | Al content | Y content |
| particles | (nm) | (atom %) | (atom %) | (atom %) |
| Goethite | 76.2 | 39.7 | 20.2 | 20.4 |
| particles 1 | | | | |
| Goethite | 73.9 | 40.2 | 20.3 | 22.0 |
| particles 2 | | | | |
| Goethite | 91.5 | 29.5 | 16.2 | 11.1 |
| particles 3 | | | | |
| Goethite | 74.4 | 41.6 | 23.8 | 16.3 |
| particles 4 | | | | |
| Goethite | 145.7 | 19.9 | 8.1 | 5.4 |
| particles 5 | | | | |

### Examples 1-2 to 1-6 and Comparative Examples 1-1 to 1-5

The same procedure as defined in Example 1-1 was conducted except that kind of goethite particles used as a raw material, heat-treatment temperature and time, heat-dehydration temperature and time, and amount of steam, were changed variously, thereby obtaining ferromagnetic metal particles.

The production conditions used above are shown in Table 2, and various properties of the thus obtained ferromagnetic metal particles are shown in Table 3.

TABLE 2

| | Production conditions of ferromagnetic | | |
|---|---|---|---|
| Examples and | metal particles | | |
| Comparative | Kind of | Heat treatment | |
| Examples | precursor | Temperature (° C.) | Time (min) |
| Ex. 1-1 | Goethite | 180 | 30 |
| | particles 1 | | |
| Ex. 1-2 | Goethite | 150 | 15 |
| | particles 2 | | |
| Ex. 1-3 | Goethite | 180 | 20 |
| | particles 3 | | |
| Ex. 1-4 | Goethite | 120 | 45 |
| | particles 4 | | |
| Ex. 1-5 | Goethite | 200 | 20 |
| | particles 5 | | |
| Ex. 1-6 | Goethite | 110 | 50 |
| | particles 1 | | |
| Comp. Ex. 1-1 | Goethite | — | — |
| | particles 1 | | |
| Comp. Ex. 1-2 | Goethite | 80 | 30 |
| | particles 1 | | |
| Comp. Ex. 1-3 | Goethite | 300 | 30 |
| | particles 1 | | |
| Comp. Ex. 1-4 | Goethite | 180 | 30 |
| | particles 1 | | |
| Comp. Ex. 1-5 | Goethite | 180 | 30 |
| | particles 1 | | |

| | Production conditions of | | |
|---|---|---|---|
| | ferromagnetic metal particles | | |
| Examples and | Heat-dehydration treatment | | |
| Comparative | Temperature | Time | Amount of |
| Examples | (° C.) | (min) | steam (vol %) |
| Ex. 1-1 | 440 | 30 | 98 |
| Ex. 1-2 | 420 | 60 | 100 |
| Ex. 1-3 | 400 | 60 | 97 |
| Ex. 1-4 | 350 | 90 | 100 |
| Ex. 1-5 | 460 | 45 | 95 |
| Ex. 1-6 | 440 | 30 | 98 |
| Comp. Ex. 1-1 | 440 | 30 | 98 |
| Comp. Ex. 1-2 | 440 | 30 | 98 |
| Comp. Ex. 1-3 | 440 | 30 | 98 |
| Comp. Ex. 1-4 | 440 | 30 | — |
| Comp. Ex. 1-5 | 440 | 30 | 85 |

TABLE 3

| | Properties of ferromagnetic metal particles | | | |
|---|---|---|---|---|
| | | | | BET |
| | | Average | | specific |
| Examples and | | major axis | | surface |
| Comparative | Particle | diameter L | Aspect | area value |
| Examples | shape | (nm) | ratio (—) | (m²/g) |
| Ex. 1-1 | Acicular | 42.2 | 3.6 | 76.5 |
| Ex. 1-2 | Acicular | 38.0 | 3.0 | 83.3 |
| Ex. 1-3 | Acicular | 53.4 | 3.9 | 64.9 |
| Ex. 1-4 | Acicular | 41.2 | 3.7 | 81.7 |
| Ex. 1-5 | Acicular | 78.8 | 4.4 | 59.1 |
| Ex. 1-6 | Acicular | 41.7 | 3.6 | 77.4 |
| Comp. Ex. 1-1 | Acicular | 43.5 | 4.0 | 100.7 |
| Comp. Ex. 1-2 | Acicular | 43.2 | 3.8 | 98.6 |
| Comp. Ex. 1-3 | Acicular | 43.4 | 4.0 | 94.4 |
| Comp. Ex. 1-4 | Acicular | 42.7 | 3.8 | 88.2 |
| Comp. Ex. 1-5 | Acicular | 42.4 | 3.7 | 84.5 |
| | Properties of ferromagnetic metal particles | | | |
| | | Geometrical | | |
| | Content of | standard | | |
| | fine | deviation | | |
| | particle | value (major | | |
| Examples and | components | axis | Co | Al |
| Comparative | (<10 nm) | diameter) | content | content |
| Examples | (%) | (—) | (atom %) | (atom %) |
| Ex. 1-1 | 7 | 1.49 | 39.9 | 20.1 |
| Ex. 1-2 | 8 | 1.55 | 40.1 | 20.2 |
| Ex. 1-3 | 7 | 1.47 | 29.6 | 16.3 |
| Ex. 1-4 | 9 | 1.56 | 41.5 | 23.7 |
| Ex. 1-5 | 6 | 1.44 | 20.0 | 8.2 |
| Ex. 1-6 | 13 | 1.78 | 39.8 | 20.2 |
| Comp. Ex. 1-1 | 26 | 2.07 | 39.8 | 20.2 |
| Comp. Ex. 1-2 | 22 | 1.97 | 39.7 | 20.0 |
| Comp. Ex. 1-3 | 20 | 2.03 | 39.6 | 20.1 |
| Comp. Ex. 1-4 | 18 | 1.91 | 39.8 | 20.3 |
| Comp. Ex. 1-5 | 17 | 1.87 | 39.9 | 20.0 |

| | Properties of ferromagnetic metal particles | | | |
|---|---|---|---|---|
| | | Coercive | Saturation | |
| Examples and | | force | magnetization | Particle |
| Comparative | Y content | value Hc | value σs | SFD |
| Examples | (atom %) | (kA/m) | (Am²/kg) | (—) |
| Ex. 1-1 | 20.5 | 183.0 | 104.4 | 0.95 |
| Ex. 1-2 | 22.1 | 177.1 | 101.9 | 1.01 |
| Ex. 1-3 | 11.0 | 184.1 | 113.6 | 0.81 |
| Ex. 1-4 | 16.2 | 182.6 | 103.8 | 0.97 |
| Ex. 1-5 | 5.5 | 190.2 | 130.2 | 0.61 |
| Ex. 1-6 | 20.4 | 181.3 | 102.8 | 1.00 |
| Comp. Ex. 1-1 | 20.5 | 175.6 | 98.3 | 1.22 |
| Comp. Ex. 1-2 | 20.4 | 178.4 | 99.1 | 1.17 |
| Comp. Ex. 1-3 | 20.6 | 179.1 | 99.5 | 1.15 |
| Comp. Ex. 1-4 | 20.3 | 179.9 | 100.7 | 1.10 |
| Comp. Ex. 1-5 | 20.4 | 180.9 | 101.4 | 1.05 |

### <Production of Magnetic Recording Medium>

### Examples 2-2 to 2-6 and Comparative Examples 2-1 to 2-5

The same procedure as defined in Example 2-1 was conducted except that kind of ferromagnetic metal particles used were changed variously, thereby obtaining magnetic recording media.

The production conditions used above and various properties of the thus obtained magnetic recording media are shown in Table 4.

TABLE 4

| | Production of | | |
|---|---|---|---|
| | magnetic | | |
| | recording | | |
| | medium | Properties of magnetic | |
| | Kind of | recording medium | |
| Examples and | ferromagnetic | Coercive force | |
| Comparative | metal | value Hc | Squareness |
| Examples | particles | (kA/m) | (—) |
| Ex. 2-1 | Ex. 1-1 | 197.6 | 0.782 |
| Ex. 2-2 | Ex. 1-2 | 191.8 | 0.790 |
| Ex. 2-3 | Ex. 1-3 | 198.7 | 0.787 |
| Ex. 2-4 | Ex. 1-4 | 196.6 | 0.776 |
| Ex. 2-5 | Ex. 1-5 | 204.0 | 0.798 |
| Ex. 2-6 | Ex. 1-6 | 195.5 | 0.755 |
| Comp. Ex. 2-1 | Comp. Ex. 1-1 | 189.1 | 0.729 |
| Comp. Ex. 2-2 | Comp. Ex. 1-2 | 192.9 | 0.733 |
| Comp. Ex. 2-3 | Comp. Ex. 1-3 | 193.3 | 0.735 |
| Comp. Ex. 2-4 | Comp. Ex. 1-4 | 194.2 | 0.747 |
| Comp. Ex. 2-5 | Comp. Ex. 1-5 | 195.1 | 0.751 |

Properties of magnetic
recording medium

| Examples and | | Surface |
|---|---|---|
| Comparative | SFD | roughness Ra |
| Examples | (—) | (nm) |
| Ex. 2-1 | 0.526 | 3.9 |
| Ex. 2-2 | 0.532 | 4.2 |
| Ex. 2-3 | 0.515 | 4.3 |
| Ex. 2-4 | 0.532 | 4.1 |
| Ex. 2-5 | 0.477 | 4.4 |
| Ex. 2-6 | 0.544 | 5.3 |
| Comp. Ex. 2-1 | 0.654 | 6.9 |
| Comp. Ex. 2-2 | 0.648 | 6.7 |
| Comp. Ex. 2-3 | 0.646 | 6.6 |
| Comp. Ex. 2-4 | 0.635 | 6.5 |
| Comp. Ex. 2-5 | 0.629 | 6.3 |

### Example 3-1

### Production of Ferromagnetic Metal Particles

### <Goethite Particles 6: Production of Goethite Particles>

### <Production Reaction of Goethite Core Crystal Particles>

28 L of a mixed alkali aqueous solution comprising ammonium hydrogencarbonate and aqueous ammonia in amounts of 20 mol and 60 mol, respectively, was charged into a reaction column container, and conditioned to 50° C. in a non-oxidative atmosphere while stirring and flowing a nitrogen gas therethrough. Then, 16 L of a 1.25 mol/L ferrous sulfate aqueous solution was charged into the reaction container, and the contents of the reaction container were aged therein for 30 min. Thereafter, 4 L of a 1.0 mol/L cobalt sulfate aqueous solution (corresponding to 20 atom % in terms of Co based on whole Fe) was added to the reaction container, and the contents of the reaction container were further aged for 2.5 hr.

Next, while stirring, an ammonium peroxodisulfate aqueous solution as an oxidizing agent was added to the reaction container in an amount capable of oxidizing 5.2% of whole Fe²⁺ in the solution, and the contents in the reaction container were allowed to stand for 10 min for obtaining a uniform mixture. Thereafter, air was passed through the reaction container at a flow rate of 0.82 L/min to conduct the oxidation reaction until reaching an oxidation percentage of 30% based on whole Fe²⁺, thereby obtaining goethite core crystal particles.

### <Growth Reaction of Goethite Layer>

Then, 2.50 L of a 1.6 mol/L aluminum sulfate aqueous solution (corresponding to 20 atom % in terms of Al based on whole Fe) was added to the reaction container, and the oxidation reaction was further continued until completion of the oxidation reaction while passing air therethrough at a flow rate of 0.82 L/min. It was confirmed that the pH value of the reaction solution upon termination of the reaction was 8.3.

The thus obtained slurry comprising goethite particles was filtered by an ordinary method to separate the goethite particles therefrom, and the thus separated goethite particles were washed with water and then re-dispersed in water, followed by adding a cobalt acetate aqueous solution (20 atom % based on whole Fe) to the resulting dispersion and sufficiently stirring the mixture. Next, while stirring the mixture, a sodium carbonate aqueous solution was added thereto to adjust a pH value of the resulting aqueous solution to 8.8. Then, a yttrium nitrate aqueous solution (20 atom % based on whole Fe) was added to the aqueous solution, and the resulting slurry was mixed under stirring. Further, a sodium carbonate aqueous solution was added to the slurry to adjust a pH value of the slurry to 9.3. Thereafter, the slurry was successively filtered to separate the particles therefrom, and the thus separated particles were washed with water and then dried, thereby obtaining a dried solid product of goethite particles.

It was confirmed that the thus obtained goethite particles had an average major axis diameter of 75.5 nm, a Co content of 39.8 atom % based on whole Fe, an Al content of 20.2 atom % based on whole Fe, and a Y content of 20.4 atom % based on whole Fe.

The thus obtained goethite particles 6 were subjected to heat-dehydration treatment and heat-reduction treatment by the same method as defined in Example 1-1, thereby obtaining ferromagnetic metal particles on the surface of which a stable surface oxidation layer was formed.

The resulting ferromagnetic metal particles of Example 3-1 were particles having an acicular shape, an average major axis diameter of 41.6 nm, an aspect ratio of 3.5 and a BET specific surface area value of 77.0 m²/g. The content of fine particles (particles having a major axis diameter of not more than 10 nm) being present in the ferromagnetic metal particles was 5%, and the geometrical standard deviation value of the major axis diameters was 1.47. The content of Co in the ferromagnetic metal particles was 40.0 atom % in terms of Co based on whole Fe; the content of Al therein was 20.1 atom % in terms of Al based on whole Fe; and the content of Y therein was 20.3 atom % in terms of Y element based on whole Fe. In addition, as to the magnetic properties of the ferromagnetic metal particles, the coercive force value Hc thereof was 182.8 kA/m; the saturation magnetization value σs thereof was 104.3 Am²/kg; and the particle SFD thereof was 0.94.

### Example 4-1

### Production of Magnetic Recording Medium

### <Non-Magnetic Undercoat Layer Composition>

The same non-magnetic undercoat layer composition as defined in Example 2-1 was used.

### <Magnetic Recording Layer Composition>

The magnetic recording layer composition was produced with the same composition and by the same method as defined in Example 2-1 except that 100.0 parts by weight of the ferromagnetic metal particles obtained in Example 3-1 were used in place of the ferromagnetic metal particles obtained in Example 1-1.

The non-magnetic undercoat layer coating material was produced from the above non-magnetic undercoat layer composition, and the magnetic recording layer coating material was produced by the same method as defined in Example 2-1 except for using the above magnetic recording layer composition. Further, the magnetic recording medium was produced by the same method as defined in Example 2-1 except for using these coating materials.

The resulting magnetic recording medium had a coercive force value of 197.5 kA/m; a squareness (Br/Bm) of 0.786; a switching field distribution SFD of 0.523; and a surface roughness Ra of 3.8 nm.

Thus, the ferromagnetic metal particles and the magnetic recording medium were produced according to Example 3-1 and Example 4-1. The production conditions used in these Examples and various properties of the thus obtained ferromagnetic metal particles and the magnetic recording medium are shown in the Tables below.

### Goethite Particles 7 to 11:

The goethite particles were produced by the same method as used for production of the goethite particles 6 as a precursor of the ferromagnetic metal particles of Example 3-1 except that the amount of cobalt compound added, the addition time and amount of aluminum compound, the amount of oxidizing agent added, and the kind and amount of anti-sintering agent added, were changed variously.

The production conditions used above and various properties of the thus obtained goethite particles are shown in Table 5.

TABLE 5

| | Production of goethite particles | | | |
|---|---|---|---|---|
| | Production reaction of goethite core crystal | | | |
| | particles | | | |
| | Oxidizing agent | | Cobalt compound | |
| | | Fe²⁺ | | Amount |
| | | oxidation | | added |
| Goethite | | percentage | | (Co/Fe) |
| particles | Kind | (%) | Kind | (atom %) |
| Goethite | Ammonium | 5.2 | Cobalt | 20 |
| particles 6 | peroxodisulfate | | sulfate | |
| Goethite | Ammonium | 6.6 | Cobalt | 30 |
| particles 7 | peroxodisulfate | | sulfate | |
| Goethite | Ammonium | 2.1 | Cobalt | 20 |
| particles 8 | peroxodisulfate | | sulfate | |
| Goethite | Ammonium | 10.4 | Cobalt | 25 |
| particles 9 | peroxodisulfate | | sulfate | |
| Goethite | Ammonium | 18.9 | Cobalt | 25 |
| particles 10 | peroxodisulfate | | sulfate | |
| Goethite | H₂O₂ | 5.2 | Cobalt | 20 |
| particles 11 | | | sulfate | |

| | Production of goethite particles | | | |
|---|---|---|---|---|
| | | | Anti-sintering | |
| | Growth reaction of | | treatment | |
| | goethite particles | | Kind of anti- | |
| | Aluminum compound | | sintering agent | |
| | | Amount | Amount of Y | Amount of |
| | | added | added | Co added |
| Goethite | | (Al/Fe) | (Y/Fe) | (Co/Fe) |
| particles | Kind | (atom %) | (atom %) | (atom %) |
| Goethite | Aluminum | 20 | 20 | 20 |
| particles 6 | sulfate | | | |
| Goethite | Aluminum | 22 | 22 | — |
| particles 7 | sulfate | | | |
| Goethite | Aluminum | 8 | 6 | — |
| particles 8 | sulfate | | | |
| Goethite | Aluminum | 20 | 20 | 20 |
| particles 9 | sulfate | | | |
| Goethite | Aluminum | 20 | 20 | 20 |
| particles 10 | sulfate | | | |
| Goethite | Aluminum | 20 | 20 | 20 |
| particles 11 | sulfate | | | |

| | Properties of goethite particles | | | |
|---|---|---|---|---|
| | Average | | Al | |
| | major axis | Co content | content | Y content |
| Goethite | diameter | (Co/Fe) | (Al/Fe) | (Y/Fe) |
| particles | (nm) | (atom %) | (atom %) | (atom %) |
| Goethite | 75.5 | 39.8 | 20.2 | 20.4 |
| particles 6 | | | | |
| Goethite | 72.6 | 29.5 | 22.5 | 22.0 |
| particles 7 | | | | |
| Goethite | 133.9 | 19.9 | 8.2 | 6.4 |
| particles 8 | | | | |
| Goethite | 49.1 | 45.6 | 20.0 | 20.3 |
| particles 9 | | | | |
| Goethite | 46.0 | 45.5 | 20.3 | 20.1 |
| particles 10 | | | | |
| Goethite | 76.7 | 40.2 | 20.2 | 20.0 |
| particles 11 | | | | |

### Examples 3-2 to 3-7 and Comparative Examples 3-1 to 3-5

The same procedure as defined in Example 1-1 was conducted except that the kind of goethite particles used as a raw material, the heat-treatment temperature and time, the heat-dehydration temperature and time and the amount of steam, were changed variously, thereby obtaining ferromagnetic metal particles.

The production conditions used above are shown in Table 6, and various properties of the thus obtained ferromagnetic metal particles are shown in Table 7.

TABLE 6

| | Production conditions of ferromagnetic metal | | |
|---|---|---|---|
| Examples and | particles | | |
| Comparative | Kind of | Heat treatment | |
| Examples | precursor | Temperature (° C.) | Time (min) |
| Ex. 3-1 | Goethite | 180 | 30 |
| | particles 6 | | |
| Ex. 3-2 | Goethite | 150 | 15 |
| | particles 7 | | |
| Ex. 3-3 | Goethite | 200 | 20 |
| | particles 8 | | |
| Ex. 3-4 | Goethite | 120 | 45 |
| | particles 9 | | |
| Ex. 3-5 | Goethite | 180 | 30 |
| | particles 10 | | |
| Ex. 3-6 | Goethite | 180 | 30 |
| | particles 11 | | |
| Ex. 3-7 | Goethite | 110 | 50 |
| | particles 6 | | |
| Comp. Ex. 3-1 | Goethite | — | — |
| | particles 6 | | |
| Comp. Ex. 3-2 | Goethite | 80 | 30 |
| | particles 6 | | |
| Comp. Ex. 3-3 | Goethite | 300 | 30 |
| | particles 6 | | |
| Comp. Ex. 3-4 | Goethite | 180 | 30 |
| | particles 6 | | |
| Comp. Ex. 3-5 | Goethite | 180 | 30 |
| | particles 6 | | |

| | Production conditions of | | |
|---|---|---|---|
| | ferromagnetic metal particles | | |
| Examples and | Heat-dehydration treatment | | |
| Comparative | Temperature | Time | Amount of |
| Examples | (° C.) | (min) | steam (vol %) |
| Ex. 3-1 | 440 | 30 | 98 |
| Ex. 3-2 | 420 | 60 | 100 |
| Ex. 3-3 | 460 | 45 | 95 |
| Ex. 3-4 | 350 | 60 | 100 |
| Ex. 3-5 | 440 | 30 | 98 |
| Ex. 3-6 | 440 | 30 | 98 |
| Ex. 3-7 | 440 | 30 | 98 |
| Comp. Ex. 3-1 | 440 | 30 | 98 |
| Comp. Ex. 3-2 | 440 | 30 | 98 |
| Comp. Ex. 3-3 | 440 | 30 | 98 |
| Comp. Ex. 3-4 | 440 | 30 | — |
| Comp. Ex. 3-5 | 440 | 30 | 85 |

TABLE 7

| | Properties of ferromagnetic metal particles | | | |
|---|---|---|---|---|
| | | | | BET |
| | | Average | | specific |
| Examples and | | major axis | | surface |
| Comparative | Particle | diameter L | Aspect | area value |
| Examples | shape | (nm) | ratio (—) | (m²/g) |
| Ex. 3-1 | Acicular | 41.6 | 3.5 | 77.0 |
| Ex. 3-2 | Acicular | 37.0 | 3.0 | 83.5 |
| Ex. 3-3 | Acicular | 77.1 | 4.4 | 61.3 |
| Ex. 3-4 | Acicular | 26.2 | 2.5 | 105.4 |
| Ex. 3-5 | Acicular | 22.3 | 2.4 | 111.7 |
| Ex. 3-6 | Acicular | 42.2 | 3.6 | 77.6 |
| Ex. 3-7 | Acicular | 41.2 | 3.6 | 78.1 |
| Comp. Ex. 3-1 | Acicular | 43.0 | 4.1 | 101.4 |
| Comp. Ex. 3-2 | Acicular | 42.7 | 3.9 | 99.2 |
| Comp. Ex. 3-3 | Acicular | 42.9 | 4.0 | 95.0 |
| Comp. Ex. 3-4 | Acicular | 42.2 | 3.8 | 88.7 |
| Comp. Ex. 3-5 | Acicular | 42.0 | 3.7 | 85.1 |
| | Properties of ferromagnetic metal particles | | | |
| | | Geometrical | | |
| | Content of | standard | | |
| | fine | deviation | | |
| | particle | value (major | | |
| Examples and | components | axis | Co | Al |
| Comparative | (<10 nm) | diameter) | content | content |
| Examples | (%) | (—) | (atom %) | (atom %) |
| Ex. 3-1 | 5 | 1.47 | 40.0 | 20.1 |
| Ex. 3-2 | 6 | 1.53 | 29.7 | 22.6 |
| Ex. 3-3 | 5 | 1.43 | 20.1 | 8.2 |
| Ex. 3-4 | 10 | 1.59 | 45.4 | 20.1 |
| Ex. 3-5 | 15 | 1.70 | 45.3 | 20.2 |
| Ex. 3-6 | 12 | 1.75 | 39.9 | 20.0 |
| Ex. 3-7 | 13 | 1.74 | 39.9 | 20.0 |
| Comp. Ex. 3-1 | 24 | 2.05 | 39.8 | 20.0 |
| Comp. Ex. 3-2 | 20 | 1.92 | 39.8 | 19.9 |
| Comp. Ex. 3-3 | 18 | 1.99 | 39.9 | 20.1 |
| Comp. Ex. 3-4 | 17 | 1.86 | 39.9 | 20.2 |
| Comp. Ex. 3-5 | 16 | 1.82 | 39.8 | 20.1 |

| | Properties of ferromagnetic metal particles | | | |
|---|---|---|---|---|
| | | Coercive | Saturation | |
| Examples and | Y | force | magnetization | Particle |
| Comparative | content | value Hc | value σs | SFD |
| Examples | (atom %) | (kA/m) | (Am²/kg) | (—) |
| Ex. 3-1 | 20.3 | 182.8 | 104.3 | 0.94 |
| Ex. 3-2 | 22.1 | 177.0 | 101.7 | 1.00 |
| Ex. 3-3 | 6.3 | 189.9 | 113.3 | 0.60 |
| Ex. 3-4 | 20.1 | 111.6 | 92.4 | 1.19 |
| Ex. 3-5 | 20.0 | 100.5 | 91.0 | 1.28 |
| Ex. 3-6 | 19.9 | 178.6 | 103.5 | 0.98 |
| Ex. 3-7 | 20.3 | 181.0 | 103.8 | 0.98 |
| Comp. Ex. 3-1 | 20.2 | 175.3 | 98.1 | 1.20 |
| Comp. Ex. 3-2 | 20.1 | 178.1 | 98.9 | 1.16 |
| Comp. Ex. 3-3 | 20.0 | 178.9 | 99.2 | 1.14 |
| Comp. Ex. 3-4 | 20.2 | 179.6 | 100.5 | 1.09 |
| Comp. Ex. 3-5 | 20.3 | 180.4 | 101.1 | 1.04 |

### <Production of Magnetic Recording Medium>

### Examples 4-2 to 4-7 and Comparative Examples 4-1 to 4-5

The same procedure as defined in Example 4-1 was conducted except that the kinds of ferromagnetic metal particles used were changed variously, thereby obtaining magnetic recording media.

The production conditions used above and various properties of the thus obtained magnetic recording media are shown in Table 8.

TABLE 8

| | Production of | | |
|---|---|---|---|
| | magnetic | | |
| | recording | | |
| | medium | Properties of magnetic | |
| | Kind of | recording medium | |
| Examples and | ferromagnetic | Coercive force | |
| Comparative | metal | value Hc | Squareness |
| Examples | particles | (kA/m) | (—) |
| Ex. 4-1 | Ex. 3-1 | 197.5 | 0.786 |
| Ex. 4-2 | Ex. 3-2 | 191.6 | 0.795 |
| Ex. 4-3 | Ex. 3-3 | 203.8 | 0.801 |
| Ex. 4-4 | Ex. 3-4 | 136.0 | 0.751 |
| Ex. 4-5 | Ex. 3-5 | 132.1 | 0.744 |
| Ex. 4-6 | Ex. 3-6 | 194.1 | 0.760 |
| Ex. 4-7 | Ex. 3-7 | 195.3 | 0.759 |
| Comp. Ex. 4-1 | Comp. Ex. 3-1 | 188.9 | 0.725 |
| Comp. Ex. 4-2 | Comp. Ex. 3-2 | 192.6 | 0.729 |
| Comp. Ex. 4-3 | Comp. Ex. 3-3 | 193.0 | 0.731 |
| Comp. Ex. 4-4 | Comp. Ex. 3-4 | 193.9 | 0.742 |
| Comp. Ex. 4-5 | Comp. Ex. 3-5 | 194.8 | 0.747 |

Properties of magnetic
recording medium

| Examples and | | Surface |
|---|---|---|
| Comparative | SFD | roughness Ra |
| Examples | (—) | (nm) |
| Ex. 4-1 | 0.523 | 3.8 |
| Ex. 4-2 | 0.536 | 4.0 |
| Ex. 4-3 | 0.481 | 4.2 |
| Ex. 4-4 | 0.661 | 4.9 |
| Ex. 4-5 | 0.725 | 5.4 |
| Ex. 4-6 | 0.544 | 5.1 |
| Ex. 4-7 | 0.547 | 5.2 |
| Comp. Ex. 4-1 | 0.651 | 6.8 |
| Comp. Ex. 4-2 | 0.646 | 6.5 |
| Comp. Ex. 4-3 | 0.642 | 6.5 |
| Comp. Ex. 4-4 | 0.630 | 6.3 |
| Comp. Ex. 4-5 | 0.625 | 6.2 |

### Example 5-1

### Production of Ferromagnetic Metal Particles

### <Goethite Particles 12: Production of Goethite Particles>

### <Production Reaction of Goethite Core Crystal Particles>

28 L of a mixed alkali aqueous solution comprising ammonium hydrogencarbonate and aqueous ammonia in amounts of 20 mol and 60 mol, respectively, was charged into a reaction column container, and conditioned to 50° C. in a non-oxidative atmosphere while stirring and flowing a nitrogen gas therethrough. Then, 16 L of a 1.25 mol/L ferrous sulfate aqueous solution was charged into the reaction container, and the contents of the reaction container were aged therein for 30 min. Thereafter, 4 L of a 1.0 mol/L cobalt sulfate aqueous solution (corresponding to 20 atom % in terms of Co based on whole Fe) was added to the reaction container, and the contents of the reaction container were further aged for 2.5 hr.

Next, air was passed through the reaction container at a flow rate of 0.82 L/min to conduct the oxidation reaction until reaching an oxidation percentage of 30% based on whole Fe²⁺, thereby obtaining goethite core crystal particles.

### <Growth Reaction of Goethite Layer>

Then, 1.25 L of a 1.6 mol/L aluminum sulfate aqueous solution (corresponding to 10 atom % in terms of Al based on whole Fe) was added at one time to the suspension comprising the goethite core crystal particles, and the oxidation reaction was further continued until reaching an oxidation percentage of 50% based on whole Fe²⁺ while passing air therethrough at a flow rate of 0.82 L/min.

Then, 0.75 L of a 1.6 mol/L aluminum sulfate aqueous solution (corresponding to 6 atom % in terms of Al based on whole Fe) was added at one time to the suspension, and the oxidation reaction was further continued until reaching an oxidation percentage of 70% based on whole Fe²⁺ while passing air therethrough at a flow rate of 0.82 L/min.

Next, 0.5 L of a 1.6 mol/L aluminum sulfate aqueous solution (corresponding to 4 atom % in terms of Al based on whole Fe) was added at one time to the suspension, and the oxidation reaction was further continued until completing the oxidation reaction while passing air therethrough at a flow rate of 0.82 L/min. It was confirmed that the pH value of the reaction solution upon completion of the reaction was 8.3.

### <Anti-Sintering Treatment of Goethite Particles>

The thus obtained slurry comprising the goethite particles was filtered by an ordinary method to separate the goethite particles therefrom, and the thus separated goethite particles were washed with water until an electric conductivity of the resulting filtrate reached not more than 100 μS, and then re-dispersed in water, followed by adding a cobalt acetate aqueous solution (in an amount corresponding to 20 atom % based on whole Fe) to the resulting dispersion and sufficiently stirring the mixture. Next, while stirring the mixture, a sodium carbonate aqueous solution was added thereto to adjust a pH value of the resulting aqueous solution to 8.8. Then, a yttrium chloride aqueous solution (in an amount corresponding to 20 atom % based on whole Fe) was added to the aqueous solution, and the resulting slurry was mixed under stirring. Further, a sodium carbonate aqueous solution was added to the slurry to adjust a pH value of the slurry to 9.3. Thereafter, the slurry was filtered to separate the particles therefrom, and the thus separated particles were washed with water and then dried, thereby obtaining a dried solid product of goethite particles.

It was confirmed that the thus obtained goethite particles had an average major axis diameter of 70.9 nm, an aspect ratio of 7.5, a BET specific surface area value of 241.7 m²/g, a Co content of 20.1 atom % in terms of Co based on whole Fe, an Al content of 20.2 atom % in terms of Al based on whole Fe, and a Y content of 20.7 atom % in terms of Y element based on whole Fe.

### <Heat-Dehydration Treatment>

The thus obtained goethite particles were heat-treated at 180° C. for 10 min and then heat-treated at 400° C. for 45 min using an overheated steam, thereby obtaining hematite particles.

### <Heat-Reduction Treatment>

The thus obtained hematite particles were charged into a reducing apparatus of a batch fixed bed type, and heat-reduced at 550° C. while passing a hydrogen gas at a flow rate of 50 cm/s. Then, after replacing the hydrogen gas with a nitrogen gas again, the obtained particles were cooled to 80° C. Successively, air was mixed with the nitrogen gas, and the amount of air mixed was gradually increased until the oxygen concentration of the mixed gas reached 0.35% by volume. Under such an atmosphere, the particles were subjected to surface-oxidation treatment, thereby forming a surface oxidation layer on the surface of the respective particles.

Next, the resulting ferromagnetic metal particles on which the surface oxidation layer was formed were heated to 600° C. in a hydrogen gas atmosphere, and the heat reduction reaction was conducted again at 600° C. while passing a hydrogen gas therethrough at a flow rate of 60 cm/s. Then, after replacing the hydrogen gas with a nitrogen gas again, the obtained particles were cooled to 80° C. Successively, 6 g/m³ of steam and air were mixed with the nitrogen gas, and the amount of air mixed was gradually increased until the oxygen concentration of the mixed gas reached 0.35% by volume. Under such an atmosphere, the particles were subjected to surface-oxidation treatment to form a stable surface oxidation layer on the surface of the respective particles, thereby producing ferromagnetic metal particles of Example 5-1.

The resulting ferromagnetic metal particles of Example 5-1 were particles having an acicular shape, an average major axis diameter of 41.0 nm, an aspect ratio of 3.8 and a BET specific surface area value of 77.9 m²/g. The contents of fine particles being present in the resulting ferromagnetic metal particles were as follows: 4% for the fine particles having a major axis diameter or a particle diameter of not more than 10 nm; and 2% for the fine particles having a major axis diameter or a particle diameter of not more than 5 nm. The geometrical standard deviation value of the major axis diameters of the ferromagnetic metal particles was 1.46. The content of Co in the ferromagnetic metal particles was 40.2 atom % in terms of Co based on whole Fe; the content of Al therein was 20.2 atom % in terms of Al based on whole Fe; and the content of Y therein was 20.9 atom % in terms of Y element based on whole Fe. In addition, as to the magnetic properties of the ferromagnetic metal particles, the coercive force value Hc thereof was 193.1 kA/m; and the saturation magnetization value as thereof was 105.0 Am²/kg.

### Example 6-1

### Production of Magnetic Recording Medium

### <Non-Magnetic Undercoat Layer Composition>

The same non-magnetic undercoat layer composition as defined in Example 2-1 was used.

### <Magnetic Recording Layer Composition>

The magnetic recording layer composition was produced with the same composition and by the same method as defined in Example 2-1 except that 100.0 parts by weight of the ferromagnetic metal particles obtained in Example 5-1 were used in place of the ferromagnetic metal particles obtained in Example 1-1.

The non-magnetic undercoat layer coating material was produced from the above non-magnetic undercoat layer composition, and the magnetic recording layer coating material was produced by the same method as defined in Example 2-1 except for using the above magnetic recording layer composition. Further, the magnetic recording medium was produced by the same method as defined in Example 2-1 except for using these coating materials.

The resulting magnetic recording medium had a coercive force value of 208.4 kA/m; a squareness (Br/Bm) of 0.792; a switching field distribution SFD of 0.515; and a surface roughness Ra of 3.2 nm.

Thus, the ferromagnetic metal particles and the magnetic recording medium were produced according to Example 5-1 and Example 6-1. The production conditions used in these Examples and various properties of the thus obtained ferromagnetic metal particles and magnetic recording medium are shown in the Tables below.

### Examples 5-2 to 5-5 and Comparative Examples 5-1 and 5-2

The same procedure as defined in Example 5-1 was conducted except that the amount of cobalt compound added, the addition time and amount of aluminum compound, and the kind and amount of anti-sintering agent added, were changed variously, thereby obtaining ferromagnetic metal particles.

Meanwhile, in Comparative Example 5-1, 2.5 L of a 1.6 mol/L aluminum sulfate aqueous solution (corresponding to 20 atom % in terms of Al based on whole Fe) was added at one time at the time at which the oxidation percentage of Fe²⁺ reached 30%. Whereas, in Comparative Example 5-2, 2.5 L of a 1.6 mol/L aluminum sulfate aqueous solution (corresponding to 20 atom % in terms of Al based on whole Fe) was gradually added over 20 min from the time at which the oxidation percentage of Fe²⁺ reached 30%.

The production conditions used above are shown in Table 9, and various properties of the thus obtained ferromagnetic metal particles are shown in Table 10.

TABLE 9

| | Production of goethite particles | | | | |
|---|---|---|---|---|---|
| | Production | | Growth reaction of goethite | | |
| | reaction of | | core crystal particles | | |
| | goethite core | | Aluminum compound | | |
| | crystal particles | | | 1st addition | |
| | Cobalt compound | | | Addition | |
| Examples | | Amount | | time: Fe²⁺ | Amount |
| and | | added | | oxidation | added |
| Comparative | | (Co/Fe) | | percentage | (Al/Fe) |
| Examples | Kind | (mol %) | Kind | (%) | (atom %) |
| Ex. 5-1 | Cobalt | 20.0 | Aluminum | 30 | 10 |
| | sulfate | | sulfate | | |
| Ex. 5-2 | Cobalt | 30.0 | Aluminum | 30 | 10 |
| | sulfate | | sulfate | | |
| Ex. 5-3 | Cobalt | 20.0 | Aluminum | 30 | 10 |
| | sulfate | | sulfate | | |
| Ex. 5-4 | Cobalt | 20.0 | Aluminum | 30 | 8 |
| | sulfate | | sulfate | | |
| Ex. 5-5 | Cobalt | 20.0 | Aluminum | 30 | 14 |
| | sulfate | | sulfate | | |
| Comp. | Cobalt | 20.0 | Aluminum | 30 | 20 |
| Ex. 5-1 | sulfate | | sulfate | | |
| Comp. | Cobalt | 20.0 | Aluminum | 30 | 20 |
| Ex. 5-2 | sulfate | | sulfate | | |

| | Production of goethite particles | | | |
|---|---|---|---|---|
| | Growth reaction of goethite core | | | |
| | crystal particles | | | |
| | Aluminum compound | | | |
| | 2nd addition | | 3rd addition | |
| | Addition | | Addition | |
| Examples | time: Fe²⁺ | Amount | time: Fe²⁺ | Amount |
| and | oxidation | added | oxidation | added |
| Comparative | percentage | (Al/Fe) | percentage | (Al/Fe) |
| Examples | (%) | (atom %) | (%) | (atom %) |
| Ex. 5-1 | 50 | 6 | 70 | 4 |
| Ex. 5-2 | 50 | 8 | 70 | 6 |
| Ex. 5-3 | 50 | 6 | 70 | 4 |
| Ex. 5-4 | 50 | 6 | 70 | 2 |
| Ex. 5-5 | 50 | 4 | 70 | 2 |
| Comp. | — | — | — | — |
| Ex. 5-1 | | | | |
| Comp. | — | — | — | — |
| Ex. 5-2 | | | | |

| | Production of goethite particles | | |
|---|---|---|---|
| | Growth reaction of | Anti-sintering | |
| | goethite core crystal | treatment | |
| | particles | Kind of anti- | |
| | Aluminum compound | sintering agent | |
| | Total amount of | Amount of Y | Amount of |
| Examples and | aluminum added | added | Co added |
| Comparative | (Al/Fe) | (Y/Fe) | (Co/Fe) |
| Examples | (atom %) | (atom %) | (atom %) |
| Ex. 5-1 | 20.0 | 20.0 | 20.0 |
| Ex. 5-2 | 24.0 | 24.0 | 10.0 |
| Ex. 5-3 | 20.0 | 22.0 | 20.0 |
| Ex. 5-4 | 16.0 | 10.0 | 10.0 |
| Ex. 5-5 | 20.0 | 20.0 | 20.0 |
| Comp. | 20.0 | 20.0 | 20.0 |
| Ex. 5-1 | | | |
| Comp. | 20.0 | 20.0 | 20.0 |
| Ex. 5-2 | | | |

TABLE 10

| | Properties of ferromagnetic metal particles | | | |
|---|---|---|---|---|
| | | | | BET |
| | | Average | | specific |
| Examples and | | major axis | Aspect | surface |
| Comparative | Particle | diameter | ratio | area value |
| Examples | shape | (nm) | (—) | (m²/g) |
| Ex. 5-1 | Acicular | 41.0 | 3.8 | 77.9 |
| Ex. 5-2 | Acicular | 28.4 | 2.6 | 94.7 |
| Ex. 5-3 | Acicular | 36.0 | 2.8 | 86.1 |
| Ex. 5-4 | Acicular | 79.2 | 4.5 | 62.2 |
| Ex. 5-5 | Acicular | 40.9 | 3.9 | 81.6 |
| Comp. Ex. 5-1 | Acicular | 37.3 | 3.6 | 102.4 |
| Comp. Ex. 5-2 | Acicular | 38.8 | 3.7 | 92.5 |

| | Properties of ferromagnetic metal particles | | | |
|---|---|---|---|---|
| | | | Geometrical | |
| | Content of fine | | standard | |
| | particle | | deviation | |
| Examples and | components | | value (major | Co |
| Comparative | <10 nm | <5 nm | axis diameter) | content |
| Examples | (%) | (%) | (—) | (atom %) |
| Ex. 5-1 | 4 | 2 | 1.46 | 40.2 |
| Ex. 5-2 | 6 | 4 | 1.58 | 40.5 |
| Ex. 5-3 | 5 | 2 | 1.51 | 40.1 |
| Ex. 5-4 | 3 | 3 | 1.40 | 30.3 |
| Ex. 5-5 | 11 | 6 | 1.74 | 39.5 |
| Comp. Ex. 5-1 | 26 | 12 | 2.09 | 40.1 |
| Comp. Ex. 5-2 | 15 | 8 | 1.87 | 40.2 |

| | Properties of ferromagnetic metal particles | | | |
|---|---|---|---|---|
| | | | Coercive | Saturation |
| Examples and | Al | Y | force value | magnetization |
| Comparative | content | content | Hc | value σs |
| Examples | (atom %) | (atom %) | (kA/m) | (Am²/kg) |
| Ex. 5-1 | 20.2 | 20.9 | 193.1 | 105.0 |
| Ex. 5-2 | 24.3 | 24.6 | 170.8 | 88.9 |
| Ex. 5-3 | 20.5 | 22.4 | 189.7 | 102.3 |
| Ex. 5-4 | 16.0 | 10.7 | 198.2 | 133.0 |
| Ex. 5-5 | 20.3 | 21.1 | 187.6 | 103.7 |
| Comp. Ex. 5-1 | 20.1 | 20.6 | 178.2 | 89.8 |
| Comp. Ex. 5-2 | 20.0 | 20.5 | 183.2 | 90.5 |

### <Production of Magnetic Recording Medium>

### Examples 6-2 to 6-5 and Comparative Examples 6-1 and 6-2

The same procedure as defined in Example 6-1 was conducted except that the kinds of ferromagnetic metal particles used were changed variously, thereby obtaining magnetic recording media.

The production conditions used above and various properties of the thus obtained magnetic recording media are shown in Table 11.

TABLE 11

| | Properties of magnetic recording medium | | | |
|---|---|---|---|---|
| | Coercive | | | |
| Examples and | force | | | Surface |
| Comparative | value Hc | Squareness | SFD | roughness Ra |
| Examples | (kA/m) | (—) | (—) | (nm) |
| Ex. 6-1 | 208.4 | 0.792 | 0.515 | 3.2 |
| Ex. 6-2 | 186.9 | 0.756 | 0.546 | 3.8 |
| Ex. 6-3 | 204.0 | 0.784 | 0.539 | 3.6 |
| Ex. 6-4 | 211.2 | 0.799 | 0.473 | 3.1 |
| Ex. 6-5 | 204.4 | 0.781 | 0.581 | 4.2 |
| Comp. Ex. 6-1 | 194.8 | 0.732 | 0.638 | 5.8 |
| Comp. Ex. 6-2 | 198.7 | 0.765 | 0.606 | 5.2 |

### Example 7-1

### Production of Ferromagnetic Metal Particles

### <Goethite Particles 13: Production of Goethite Particles>

### <Production Reaction of Goethite Core Crystal Particles>

28 L of a mixed alkali aqueous solution comprising ammonium hydrogencarbonate and aqueous ammonia in amounts of 20 mol and 60 mol, respectively, was charged into a reaction column container, and conditioned to 50° C. in a non-oxidative atmosphere while stirring and flowing a nitrogen gas therethrough. Then, 16 L of a 1.25 mol/L ferrous sulfate aqueous solution was charged into the reaction container, and the contents of the reaction container were aged therein for 30 min. Thereafter, 4 L of a 1.5 mol/L cobalt sulfate aqueous solution (corresponding to 30 atom % in terms of Co based on whole Fe) was added to the reaction container, and the contents of the reaction container were further aged for 2.5 hr.

Next, while stirring, an ammonium peroxodisulfate aqueous solution as an oxidizing agent (in an amount of 1.8 mol % based on whole Fe) was added to the reaction container, and the contents in the reaction container were allowed to stand for 10 min for obtaining a uniform mixture. Thereafter, air was passed through the reaction container at a flow rate of 0.82 L/min to conduct the oxidation reaction until reaching an oxidation percentage of 30% based on whole Fe²⁺, thereby obtaining goethite core crystal particles.

### <Growth Reaction of Goethite Layer>

Then, 1.25 L of a 1.6 mol/L aluminum sulfate aqueous solution (corresponding to 10 atom % in terms of Al based on whole Fe) was added to the suspension comprising the goethite core crystal particles, and the oxidation reaction was further continued until reaching an oxidation percentage of 50% based on whole Fe²⁺ while passing air therethrough at a flow rate of 0.82 L/min.

Then, 0.75 L of a 1.6 mol/L aluminum sulfate aqueous solution (corresponding to 6 atom % in terms of Al based on whole Fe) was added to the suspension, and the oxidation reaction was further continued until reaching an oxidation percentage of 70% based on whole Fe²⁺ while passing air therethrough at a flow rate of 0.82 L/min.

Then, 0.5 L of a 1.6 mol/L aluminum sulfate aqueous solution (corresponding to 4 atom % in terms of Al based on whole Fe) was added to the suspension, and the oxidation reaction was further continued until reaching an oxidation percentage of 95% based on whole Fe²⁺ while passing air therethrough at a flow rate of 0.82 L/min.

To the suspension comprising the goethite particles in which the oxidation percentage of whole Fe²⁺ reached 97.0%, 2.0 mol % of an ammonium peroxodisulfate aqueous solution as an oxidizing agent was added, and then the oxidation reaction was further continued until completely oxidizing Fe²⁺ into Fe³⁺ while passing air therethrough at a flow rate of 0.82 L/min. It was confirmed that the pH value of the reaction solution upon completion of the reaction was 8.3.

### <Water-Washing of Goethite Particles>

The thus obtained slurry comprising the goethite particles was filtered to separate the goethite particles therefrom, and then the thus separated goethite particles were washed with a 0.029N sodium carbonate aqueous solution and further with water until an electric conductivity of the resulting filtrate was reduced to not more than 100 μS.

### <Anti-Sintering Treatment of Goethite Particles>

The thus obtained water-washed goethite particles were re-dispersed in water. Next, while stirring the dispersion, a sodium carbonate aqueous solution was added thereto to adjust a pH value of the resulting aqueous solution to 8.8. Then, a yttrium chloride aqueous solution (in an amount corresponding to 22 atom % based on whole Fe) was added to the aqueous solution, and the resulting slurry was mixed under stirring. Further, a sodium carbonate aqueous solution was added to the slurry to adjust a pH value of the slurry to 9.3. Thereafter, according to an ordinary method, the slurry was filtered to separate the particles therefrom, and the thus separated particles were washed with water and then dried, thereby obtaining a dried solid product of goethite particles.

It was confirmed that the thus obtained goethite particles had an average major axis diameter of 73.2 nm, an aspect ratio of 7.7, a BET specific surface area value of 245.7 m²/g, a Co content of 30.1 atom % based on whole Fe, an Al content of 20.6 atom % based on whole Fe, and a Y content of 22.6 atom % based on whole Fe. Further, it was also confirmed that a residual amount of Fe²⁺ in the goethite particles was 0%; a soluble Co content therein was 8 ppm; a soluble Al content therein was less than 3 ppm (below the lower detection limit); and a soluble Y content therein was 0.5 ppm.

### <Heat-Dehydration Treatment>

The thus obtained goethite particles were heat-treated at 180° C. for 10 min and then heat-treated at 400° C. for 45 min using an overheated steam, thereby obtaining hematite particles.

### <Heat-Reduction Treatment>

The thus obtained hematite particles were charged into a reducing apparatus of a batch fixed bed type, and heat-reduced at 550° C. while passing a hydrogen gas therethrough at a flow rate of 50 cm/s. Then, after replacing the hydrogen gas with a nitrogen gas again, the obtained particles were cooled to 80° C. Successively, air was mixed with the nitrogen gas, and the amount of air mixed was gradually increased until the oxygen concentration of the mixed gas reached 0.35% by volume. Under such an atmosphere, the particles were subjected to surface-oxidation treatment, thereby forming a surface oxidation layer on the surface of the respective particles.

Next, the resulting ferromagnetic metal particles on which the surface oxidation layer was formed were heated to 600° C. in a hydrogen gas atmosphere, and the heat-reduction reaction was conducted again at 600° C. while passing a hydrogen gas therethrough at a flow rate of 60 cm/s. Then, after replacing the hydrogen gas with a nitrogen gas again, the obtained particles were cooled to 80° C. Successively, 6 g/m³ of steam and air were mixed with the nitrogen gas, and the amount of air mixed was gradually increased until the oxygen concentration of the mixed gas reached 0.35% by volume. Under such an atmosphere, the particles were subjected to surface-oxidation treatment to form a stable surface oxidation layer on the surface of the respective particles, thereby producing ferromagnetic metal particles of Example 7-1.

The resulting ferromagnetic metal particles of Example 5-1 were particles having an acicular shape, an average major axis diameter of 41.1 nm, an aspect ratio of 3.6 and a BET specific surface area value of 88.3 m²/g. Also, the dispersed behavior particles of the ferromagnetic metal particles had an average particle diameter of 110.3 nm, and a geometrical standard deviation value of volume-based particle diameters thereof was 1.62. The content of Co in the ferromagnetic metal particles was 30.1 atom % in terms of Co based on whole Fe; the content of Al therein was 20.3 atom % in terms of Al based on whole Fe; and the content of Y therein was 22.2 atom % in terms of Y element based on whole Fe. In addition, as to the magnetic properties of the ferromagnetic metal particles, the coercive force value Hc thereof was 196.6 kA/m; and the saturation magnetization value cys thereof was 102.1 μm²/kg.

### Example 8-1

### Production of Magnetic Recording Medium

### <Non-Magnetic Undercoat Layer Composition>

The same non-magnetic undercoat layer composition as defined in Example 2-1 was used.

### <Magnetic Recording Layer Composition>

The magnetic recording layer composition was produced with the same composition and by the same method as defined in Example 2-1 except that 100.0 parts by weight of the ferromagnetic metal particles obtained in Example 7-1 were used in place of the ferromagnetic metal particles obtained in Example 1-1.

The non-magnetic undercoat layer coating material was produced from the above non-magnetic undercoat layer composition, and the magnetic recording layer coating material was produced by the same method as defined in Example 2-1 except for using the above magnetic recording layer composition. Further, the magnetic recording medium was produced by the same method as defined in Example 2-1 except for using these coating materials.

The resulting magnetic recording medium had a coercive force value of 207.5 kA/m; a squareness (Br/Bm) of 0.788; a switching field distribution SFD of 0.472; and a surface roughness Ra of 2.7 nm.

Thus, the ferromagnetic metal particles and the magnetic recording medium were produced according to Example 7-1 and Example 8-1. The production conditions used in these Examples and various properties of the thus obtained ferromagnetic metal particles and magnetic recording medium are shown in the Tables below.

### Goethite Particles 14, 15 and 19 to 22:

The goethite particles were produced by the same method as used for production of the goethite particles 13 as a precursor of the ferromagnetic metal particles of Example 7-1 except that the amount of cobalt compound added, the addition time and amount of aluminum compound, the amount of oxidizing agent added, the use or non-use of water-washing step, and the kind and amount of anti-sintering agent added, were changed variously.

Meanwhile, upon production of the goethite particles 19, 2.5 L of a 1.6 mol/L aluminum sulfate aqueous solution (corresponding to 20 atom % in terms of Al based on whole Fe) was added at one time at the time at which the oxidation percentage of Fe²⁺ reached 30%. Whereas, upon production of the goethite particles 20, 2.5 L of a 1.6 mol/L aluminum sulfate aqueous solution (corresponding to 20 atom % in terms of Al based on whole Fe) was added at one time at the time at which the oxidation percentage of Fe²⁺ reached 30%, but no oxidation reaction using the oxidizing agent was subsequently conducted.

The production conditions used above are shown in Table 4, and various properties of the thus obtained ferromagnetic metal particles are shown in Table 5.

Goethite Particles 16:

### <Production Reaction of Goethite Core Crystal Particles>

28 L of a mixed alkali aqueous solution comprising ammonium hydrogencarbonate and aqueous ammonia in amounts of 20 mol and 60 mol, respectively, was charged into a reaction column container, and conditioned to 50° C. in a non-oxidative atmosphere while stirring and flowing a nitrogen gas therethrough. Then, 16 L of a 1.25 mol/L ferrous sulfate aqueous solution was charged into the reaction container, and the contents of the reaction container were aged therein for 30 min. Thereafter, 4 L of a 1.5 mol/L cobalt sulfate aqueous solution (corresponding to 30 atom % in terms of Co based on whole Fe) was added to the reaction container, and the contents of the reaction container were further aged for 2.5 hr.

Next, air was passed through the reaction container at a flow rate of 0.82 L/min to conduct the oxidation reaction until reaching an oxidation percentage of 30% based on whole Fe²⁺, thereby obtaining goethite core crystal particles.

### <Growth Reaction of Goethite Layer>

Then, 1.0 L of a 1.6 mol/L aluminum sulfate aqueous solution (corresponding to 8 atom % in terms of Al based on whole Fe) was added to the suspension comprising the goethite core crystal particles, and the oxidation reaction was further continued until reaching an oxidation percentage of 50% based on whole Fe²⁺ while passing air therethrough at a flow rate of 0.82 L/min.

Then, 0.75 L of a 1.6 mol/L aluminum sulfate aqueous solution (corresponding to 6 atom % in terms of Al based on whole Fe) was added to the suspension, and the oxidation reaction was further continued until reaching an oxidation percentage of 70% based on whole Fe²⁺ while passing air therethrough at a flow rate of 0.82 L/min.

Then, 0.25 L of a 1.6 mol/L aluminum sulfate aqueous solution (corresponding to 4 atom % in terms of Al based on whole Fe) was added to the suspension, and the oxidation reaction was further continued until reaching an oxidation percentage of 95% based on whole Fe²⁺ while passing air therethrough at a flow rate of 0.82 L/min.

To the suspension comprising the goethite particles in which the oxidation percentage of whole Fe²⁺ reached 97.0%, 2.0 mol % of an ammonium peroxodisulfate aqueous solution as an oxidizing agent was added, and then the oxidation reaction was further continued until completely oxidizing Fe²⁺ into Fe³⁺ while passing air therethrough at a flow rate of 0.82 L/min. It was confirmed that the pH value of the reaction solution upon completion of the reaction was 8.3.

### <Water-Washing of Goethite Particles>

The thus obtained slurry comprising the goethite particles was filtered to separate the goethite particles therefrom, and then the thus separated goethite particles were washed with a 0.029N sodium carbonate aqueous solution and further with water until an electric conductivity of the resulting filtrate was reduced to not more than 100 μS.

### <Anti-Sintering Treatment of Goethite Particles>

The thus obtained water-washed goethite particles were re-dispersed in water. Next, while stirring the dispersion, a sodium carbonate aqueous solution was added thereto to adjust a pH value of the resulting aqueous solution to 8.8. Then, a yttrium chloride aqueous solution (in an amount corresponding to 10 atom % in terms of Y element based on whole Fe) was added to the aqueous solution, and the resulting slurry was mixed under stirring. Further, a sodium carbonate aqueous solution was added to the slurry to adjust a pH value of the slurry to 9.3. Thereafter, according to an ordinary method, the slurry was filtered to separate the particles therefrom, and the thus separated particles were washed with water and then dried, thereby obtaining a dried solid product of goethite particles.

### Goethite Particles 17 and 18:

The goethite particles were produced by the same method as used for production of the goethite particles 16 except that the amount of cobalt compound added, the addition time and amount of aluminum compound, the amount of oxidizing agent added, the degree of water-washing, and the amount of anti-sintering agent added, were changed variously.

Meanwhile, upon production of the goethite particles 18, no oxidation reaction using the oxidizing agent was conducted subsequent to intermittently adding the aluminum compound in divided parts.

The production conditions used above are shown in Table 12, and various properties of the thus obtained goethite particles are shown in Table 13.

TABLE 12

Production of goethite particles
Production reaction of goethite
core crystal particles

Cobalt compound

| | | | Amount added |
|---|---|---|---|
| Goethite | Oxidation | | (Co/Fe) |
| particles | method | Kind | (mol %) |
| Goethite | Oxidizing | Cobalt sulfate | 30.0 |
| particles 13 | agent | | |
| Goethite | Oxidizing | Cobalt sulfate | 30.0 |
| particles 14 | agent | | |
| Goethite | Oxidizing | Cobalt sulfate | 34.0 |
| particles 15 | agent | | |
| Goethite | Air | Cobalt sulfate | 30.0 |
| particles 16 | | | |
| Goethite | Air | Cobalt sulfate | 30.0 |
| particles 17 | | | |
| Goethite | Air | Cobalt sulfate | 20.0 |
| particles 18 | | | |
| Goethite | Oxidizing | Cobalt sulfate | 30.0 |
| particles 19 | agent | | |
| Goethite | Oxidizing | Cobalt sulfate | 30.0 |
| particles 20 | agent | | |
| Goethite | Oxidizing | Cobalt sulfate | 30.0 |
| particles 21 | agent | | |
| Goethite | Oxidizing | Cobalt sulfate | 20.0 |
| particles 22 | agent | | |

| | Production of goethite particles | | | | |
|---|---|---|---|---|---|
| | Growth reaction of goethite core crystal | | | | |
| | particles | | | | |
| | Aluminum compound | | | | |
| | | 1st addition | | 2nd addition | |
| | | Addition | | Addition | |
| | | time: Fe²⁺ | Amount | time: Fe²⁺ | Amount |
| | | oxidation | added | oxidation | added |
| Goethite | | percentage | (Al/Fe) | percentage | (Al/Fe) |
| particles | Kind | (%) | (atom %) | (%) | (atom %) |
| Goethite | Aluminum | 30 | 10 | 50 | 6 |
| particles | sulfate | | | | |
| 13 | | | | | |
| Goethite | Aluminum | 30 | 10 | 50 | 8 |
| particles | sulfate | | | | |
| 14 | | | | | |
| Goethite | Aluminum | 30 | 10 | 50 | 6 |
| particles | sulfate | | | | |
| 15 | | | | | |
| Goethite | Aluminum | 30 | 8 | 50 | 6 |
| particles | sulfate | | | | |
| 16 | | | | | |
| Goethite | Aluminum | 30 | 10 | 50 | 6 |
| particles | sulfate | | | | |
| 17 | | | | | |
| Goethite | Aluminum | 30 | 10 | 50 | 6 |
| particles | sulfate | | | | |
| 18 | | | | | |
| Goethite | Aluminum | 30 | 20 | — | — |
| particles | sulfate | | | | |
| 19 | | | | | |
| Goethite | Aluminum | 30 | 20 | — | — |
| particles | sulfate | | | | |
| 20 | | | | | |
| Goethite | Aluminum | 30 | 10 | 50 | 6 |
| particles | sulfate | | | | |
| 21 | | | | | |
| Goethite | Aluminum | 30 | 10 | 50 | 6 |
| particles | sulfate | | | | |
| 22 | | | | | |

| | Production of goethite particles | | |
|---|---|---|---|
| | Growth reaction of goethite core | | |
| | crystal particles | | |
| | Aluminum compound | | |
| | 3rd addition | | Total amount of |
| | Addition time: | Amount added | aluminum added |
| Goethite | Fe²⁺ oxidation | (Al/Fe) | (Al/Fe) |
| particles | percentage (%) | (atom %) | (atom %) |
| Goethite | 70 | 4 | 20.0 |
| particles 13 | | | |
| Goethite | 70 | 6 | 24.0 |
| particles 14 | | | |
| Goethite | 70 | 4 | 20.0 |
| particles 15 | | | |
| Goethite | 70 | 2 | 16.0 |
| particles 16 | | | |
| Goethite | 70 | 4 | 20.0 |
| particles 17 | | | |
| Goethite | 70 | 4 | 20.0 |
| particles 18 | | | |
| Goethite | — | — | 20.0 |
| particles 19 | | | |
| Goethite | — | — | 20.0 |
| particles 20 | | | |
| Goethite | 70 | 4 | 20.0 |
| particles 21 | | | |
| Goethite | 70 | 4 | 20.0 |
| particles 22 | | | |

| | Production of goethite particles | | |
|---|---|---|---|
| | Growth reaction of goethite core | | |
| | crystal particles | | |
| | Oxidizing agent | | |
| | Amount | Before addition: | After addition: |
| Goethite | added | Fe²⁺ oxidation | Fe²⁺ oxidation |
| particles | (mol %) | percentage (%) | percentage (%) |
| Goethite | 2.0 | 97.0 | 100.0 |
| particles 13 | | | |
| Goethite | 3.0 | 95.0 | 100.0 |
| particles 14 | | | |
| Goethite | 4.5 | 92.0 | 100.0 |
| particles 15 | | | |
| Goethite | 2.0 | 97.0 | 100.0 |
| particles 16 | | | |
| Goethite | 2.5 | 96.0 | 100.0 |
| particles 17 | | | |
| Goethite | — | 99.5 | 99.5 |
| particles 18 | | | |
| Goethite | 2.0 | 97.0 | 100.0 |
| particles 19 | | | |
| Goethite | — | 97.0 | 97.0 |
| particles 20 | | | |
| Goethite | 2.0 | 97.0 | 100.0 |
| particles 21 | | | |
| Goethite | 1.0 | 99.0 | 100.0 |
| particles 22 | | | |

| | Production of goethite particles | | | |
|---|---|---|---|---|
| | | | Anti-sintering | |
| | | | treatment | |
| | Water- | | Kind of anti- | |
| | washing step | | sintering agent | |
| | Use or non- | Degree of | Amount of | Amount of |
| | use of | water- | Y added | Co added |
| Goethite | water- | washing | (Y/Fe) | (Co/Fe) |
| particles | washing | (μS) | (atom %) | (atom %) |
| Goethite | Used | 45 | 22.0 | — |
| particles 13 | | | | |
| Goethite | Used | 55 | 27.0 | — |
| particles 14 | | | | |
| Goethite | Used | 50 | 24.0 | — |
| particles 15 | | | | |
| Goethite | Used | 45 | 10.0 | — |
| particles 16 | | | | |
| Goethite | Used | 45 | 20.0 | — |
| particles 17 | | | | |
| Goethite | Used | 60 | 15.0 | — |
| particles 18 | | | | |
| Goethite | Used | 45 | 22.0 | — |
| particles 19 | | | | |
| Goethite | Used | 45 | 22.0 | — |
| particles 20 | | | | |
| Goethite | Not used | — | 22.0 | — |
| particles 21 | | | | |
| Goethite | Used | 45 | 22.0 | 10.0 |
| particles 22 | | | | |

TABLE 13

Properties of goethite particles

| | | | | BET |
|---|---|---|---|---|
| | | Average | | specific |
| | | major axis | Aspect | surface |
| Goethite | Particle | diameter | ratio | area value |
| Particles | shape | (nm) | (—) | (m²/g) |
| Goethite | Acicular | 73.2 | 7.7 | 245.7 |
| particles 13 | | | | |
| Goethite | Acicular | 57.4 | 8.0 | 275.2 |
| particles 14 | | | | |
| Goethite | Acicular | 71.8 | 7.2 | 250.0 |
| particles 15 | | | | |
| Goethite | Acicular | 143.3 | 6.0 | 181.4 |
| particles 16 | | | | |
| Goethite | Acicular | 75.9 | 7.6 | 237.3 |
| particles 17 | | | | |
| Goethite | Acicular | 74.7 | 7.6 | 223.5 |
| particles 18 | | | | |
| Goethite | Acicular | 66.8 | 5.5 | 270.6 |
| particles 19 | | | | |
| Goethite | Acicular | 66.1 | 5.5 | 268.1 |
| particles 20 | | | | |
| Goethite | Acicular | 89.3 | 7.0 | 218.5 |
| particles 21 | | | | |
| Goethite | Acicular | 72.3 | 7.2 | 221.4 |
| particles 22 | | | | |

| | Properties of goethite particles | | | |
|---|---|---|---|---|
| | Co | | | Residual |
| | content | Al content | Y content | Fe²⁺ |
| Goethite | (Co/Fe) | (Al/Fe) | (Y/Fe) | amount |
| particles | (atom %) | (atom %) | (atom %) | (ppm) |
| Goethite | 30.1 | 20.6 | 22.6 | 0 |
| particles 13 | | | | |
| Goethite | 30.3 | 24.1 | 27.0 | 0 |
| particles 14 | | | | |
| Goethite | 33.8 | 20.0 | 24.4 | 0 |
| particles 15 | | | | |
| Goethite | 30.4 | 16.2 | 10.4 | 0 |
| particles 16 | | | | |
| Goethite | 30.1 | 19.9 | 20.3 | 0 |
| particles 17 | | | | |
| Goethite | 19.8 | 19.9 | 15.3 | 2250 |
| particles 18 | | | | |
| Goethite | 29.8 | 19.8 | 22.1 | 0 |
| particles 19 | | | | |
| Goethite | 29.7 | 19.8 | 22.0 | 8400 |
| particles 20 | | | | |
| Goethite | 29.8 | 19.7 | 21.8 | 0 |
| particles 21 | | | | |
| Goethite | 29.8 | 19.8 | 22.2 | 0 |
| particles 22 | | | | |

| | Properties of goethite particles | | |
|---|---|---|---|
| Goethite | Soluble Co | Soluble Al | Soluble Y |
| particles | content (ppm) | content (ppm) | content (ppm) |
| Goethite | 8 | <3 | 0.5 |
| particles 13 | | | |
| Goethite | 9 | <3 | 0.8 |
| particles 14 | | | |
| Goethite | 6 | <3 | 0.5 |
| particles 15 | | | |
| Goethite | 3 | <3 | 0.3 |
| particles 16 | | | |
| Goethite | 5 | <3 | 0.6 |
| particles 17 | | | |
| Goethite | 16 | <3 | 0.9 |
| particles 18 | | | |
| Goethite | 54 | 12 | 0.5 |
| particles 19 | | | |
| Goethite | 60 | 17 | 0.5 |
| particles 20 | | | |
| Goethite | 139 | <3 | 0.4 |
| particles 21 | | | |
| Goethite | 78 | <3 | 0.5 |
| particles 22 | | | |

### Examples 7-2 to 7-6 and Comparative Examples 7-1 to 7-4

The same procedure as defined in Example 7-1 was conducted except that the kind of goethite particles as a precursor was changed variously, thereby obtaining ferromagnetic metal particles.

The production conditions used above and various properties of the thus obtained ferromagnetic metal particles are shown in Table 14.

TABLE 14

| | | Properties of ferromagnetic | | | |
|---|---|---|---|---|---|
| | | metal particles | | | |
| | | | | | BET |
| | | | Average | | specific |
| Examples | | | major | | surface |
| and | | | axis | Aspect | area |
| Comparative | Kind of | Particle | diameter | ratio | value |
| Examples | precursor | shape | (nm) | (—) | (m²/g) |
| Ex. 7-1 | Goethite | Acicular | 41.1 | 3.6 | 88.3 |
| | particles | | | | |
| | 13 | | | | |
| Ex. 7-2 | Goethite | Acicular | 23.9 | 2.6 | 98.0 |
| | particles | | | | |
| | 14 | | | | |
| Ex. 7-3 | Goethite | Acicular | 35.8 | 3.4 | 93.3 |
| | particles | | | | |
| | 15 | | | | |
| Ex. 7-4 | Goethite | Acicular | 78.4 | 4.3 | 59.2 |
| | particles | | | | |
| | 16 | | | | |
| Ex. 7-5 | Goethite | Acicular | 39.2 | 3.5 | 86.8 |
| | particles | | | | |
| | 17 | | | | |
| Ex. 7-6 | Goethite | Acicular | 41.5 | 3.7 | 88.5 |
| | particles | | | | |
| | 18 | | | | |
| Comp. | Goethite | Acicular | 37.5 | 2.9 | 110.0 |
| Ex. 7-1 | particles | | | | |
| | 19 | | | | |
| Comp. | Goethite | Acicular | 37.2 | 2.8 | 111.8 |
| Ex. 7-2 | particles | | | | |
| | 20 | | | | |
| Comp. | Goethite | Acicular | 50.3 | 2.5 | 84.0 |
| Ex. 7-3 | particles | | | | |
| | 21 | | | | |
| Comp. | Goethite | Acicular | 40.7 | 3.4 | 86.1 |
| Ex. 7-4 | particles | | | | |
| | 22 | | | | |

| | Properties of ferromagnetic | | | |
|---|---|---|---|---|
| | metal particles | | | |
| | Diameter of dispersed | | | |
| | behavior particles | | | |
| | Average | Geometrical | | |
| Examples and | particle | standard | Co | Al |
| Comparative | diameter | deviation | content | content |
| Examples | (nm) | value (—) | (atom %) | (atom %) |
| Ex. 7-1 | 102.8 | 1.62 | 30.1 | 20.3 |
| Ex. 7-2 | 60.7 | 1.70 | 30.4 | 24.2 |
| Ex. 7-3 | 91.5 | 1.66 | 33.9 | 20.1 |
| Ex. 7-4 | 207.2 | 1.61 | 30.3 | 16.1 |
| Ex. 7-5 | 101.0 | 1.63 | 30.2 | 19.9 |
| Ex. 7-6 | 110.3 | 1.82 | 19.9 | 20.0 |
| Comp. Ex. 7-1 | 132.5 | 2.08 | 29.8 | 19.8 |
| Comp. Ex. 7-2 | 137.9 | 2.10 | 29.7 | 19.8 |
| Comp. Ex. 7-3 | 148.0 | 2.19 | 29.5 | 19.7 |
| Comp. Ex. 7-4 | 130.1 | 2.04 | 29.8 | 19.9 |

| | Properties of ferromagnetic | | |
|---|---|---|---|
| | metal particles | | |
| | | Coercive | Saturation |
| Examples and | | force value | magnetization |
| Comparative | Y content | Hc | value σs |
| Examples | (atom %) | (kA/m) | (Am²/kg) |
| Ex. 7-1 | 22.2 | 196.6 | 102.1 |
| Ex. 7-2 | 27.1 | 141.8 | 86.4 |
| Ex. 7-3 | 24.1 | 181.6 | 94.0 |
| Ex. 7-4 | 10.2 | 183.9 | 133.2 |
| Ex. 7-5 | 20.1 | 182.0 | 98.3 |
| Ex. 7-6 | 15.0 | 175.7 | 100.7 |
| Comp. Ex. 7-1 | 22.1 | 159.4 | 88.0 |
| Comp. Ex. 7-2 | 22.0 | 153.6 | 87.8 |
| Comp. Ex. 7-3 | 21.9 | 136.4 | 93.1 |
| Comp. Ex. 7-4 | 21.9 | 189.3 | 102.5 |

### <Production of Magnetic Recording Medium>

### Examples 8-2 to 8-6 and Comparative Examples 8-1 and 8-4

The same procedure as defined in Example 8-1 was conducted except that the kinds of ferromagnetic metal particles used were changed variously, thereby obtaining magnetic recording media.

The production conditions used above and various properties of the thus obtained magnetic recording media are shown in Table 15.

TABLE 15

| | Properties of magnetic recording medium | | | |
|---|---|---|---|---|
| | Coercive | | | |
| Examples and | force | | | Surface |
| Comparative | value Hc | Squareness | SFD | roughness |
| Examples | (kA/m) | (—) | (—) | Ra (nm) |
| Ex. 8-1 | 207.5 | 0.788 | 0.472 | 2.7 |
| Ex. 8-2 | 153.6 | 0.753 | 0.459 | 3.3 |
| Ex. 8-3 | 194.3 | 0.798 | 0.466 | 3.0 |
| Ex. 8-4 | 197.7 | 0.773 | 0.491 | 2.9 |
| Ex. 8-5 | 198.9 | 0.776 | 0.475 | 3.1 |
| Ex. 8-6 | 187.2 | 0.781 | 0.480 | 3.7 |
| Comp. Ex. 8-1 | 172.1 | 0.732 | 0.542 | 4.4 |
| Comp. Ex. 8-2 | 169.8 | 0.729 | 0.553 | 4.5 |
| Comp. Ex. 8-3 | 145.4 | 0.715 | 0.597 | 4.8 |
| Comp. Ex. 8-4 | 199.0 | 0.747 | 0.530 | 4.2 |

What is claimed is:

1. Ferromagnetic metal particles having an average major axis diameter (L) of 10 to 100 nm which satisfy a relationship between the average major axis diameter (L) and a particle SFD represented by the following formula:
Particle SFD≦0.0001 L²−0.0217 L+1.75.

2. Ferromagnetic metal particles according to claim 1, wherein a geometrical standard deviation value of major axis diameters of the particles is not more than 1.80.

3. Ferromagnetic metal particles according to claim 1, wherein a content of ultrafine particles having a major axis diameter of less than 10 nm based on the whole particles is not more than 15%.

4. A process for producing the ferromagnetic metal particles as defined in claim 1, comprising the steps of heat-treating goethite particles to obtain hematite particles; and then subjecting the obtained hematite particles to heat reduction, wherein the heat treatment of the goethite particles is conducted in a non-reducing atmosphere at a temperature of 100 to 250° C., and then under the condition that a steam concentration is not less than 90% by volume at a temperature of 300 to 650° C.

5. A process for producing the ferromagnetic metal particles according to claim 1, wherein particles obtained by reacting a mixed alkali aqueous solution of an alkali hydrogencarbonate aqueous solution or an alkali carbonate aqueous solution and an alkali hydroxide aqueous solution with a ferrous salt aqueous solution to obtain a water suspension comprising a ferrous-containing precipitate; aging the water suspension comprising the ferrous-containing precipitate in a non-oxidative atmosphere; producing goethite core crystal particles by an oxidizing agent; allowing a goethite layer to be grown on the surface of the respective core crystal particles, followed by washing the resulting particles with water; and then coating the surface of the thus obtained respective goethite particles with an anti-sintering agent, are used as the goethite particles.

6. A process for producing the ferromagnetic metal particles according to claim 5, wherein an ammonium peroxodisulfate aqueous solution is used as the oxidizing agent.

7. A process for producing the ferromagnetic metal particles as defined in claim 1, comprising the steps of:
reacting a mixed alkali aqueous solution of an alkali hydrogencarbonate aqueous solution or an alkali carbonate aqueous solution and an alkali hydroxide aqueous solution with a ferrous salt aqueous solution to obtain a water suspension comprising a ferrous-containing precipitate;
aging the water suspension comprising the ferrous-containing precipitate in a non-oxidative atmosphere;
producing goethite core crystal particles by oxidation reaction; and
then passing an oxygen-containing gas through the water suspension comprising the core crystal particles and the ferrous-containing precipitate to allow a goethite layer to be grown on the surface of the respective core crystal particles by oxidation reaction, thereby producing goethite,
wherein upon growth of the goethite layer, an Al compound is intermittently added in two or more divided parts according to a progress of stage of the oxidation reaction; an anti-sintering agent is added to the water suspension comprising the resulting goethite particles to coat the surface of the respective goethite particles with the anti-sintering agent; the goethite particles surface-coated with the anti-sintering agent are subjected to heat-dehydration treatment in a non-reducing atmosphere to obtain hematite particles; and the obtained hematite particles are subjected to heat reduction in a reducing atmosphere to obtain magnetic metal particles comprising iron as a main component.

8. A process for producing the ferromagnetic metal particles according to claim 7, wherein an amount of the Al compound added as one of the divided parts is not more than 12 atom % in terms of Al based on whole Fe.

9. A process for producing the ferromagnetic metal particles according to claim 7, wherein upon production of the core crystal particles, a Co compound is added to the water suspension comprising the ferrous-containing precipitate during the aging before initiation of the oxidation reaction, and then the resulting water suspension is subjected to oxidation reaction.

10. A process for producing the ferromagnetic metal particles according to claim 7, wherein after intermittently adding the Al compound in two or more divided parts according to the progress of stage of the oxidation reaction, the resulting goethite particles are separated by filtration; the goethite particles are washed with water until an electric conductivity of a filtrate obtained from the water-washing reaches not more than 100 μS; and then the anti-sintering agent is added to the water suspension comprising the resulting goethite particles.

11. A process for producing the ferromagnetic metal particles according to claim 10, wherein the anti-sintering agent is a rare earth compound.

12. A process for producing the ferromagnetic metal particles according to claim 11, wherein the goethite particles subjected to the heat-dehydration treatment and heat-reduction treatment have a soluble Co content of not more than 20 ppm.

13. A process for producing the ferromagnetic metal particles according to claim 12, wherein upon growth of the goethite layer, the Al compound is intermittently added in two or more divided parts according to the progress of stage of the oxidation reaction; and then the oxidizing agent is added to a reaction solution at the time at which the oxidation reaction proceeds such that a Fe²⁺ content in the reaction solution reaches not more than 10%, to thereby oxidize residual Fe²⁺ in the reaction solution into Fe³⁺.

14. A process for producing the ferromagnetic metal particles according to claim 13, wherein the goethite particles subjected to the heat-dehydration treatment and heat-reduction treatment have a Fe²⁺ content of not more than ppm.

15. A magnetic recording medium comprising:
a non-magnetic substrate;
a non-magnetic undercoat layer formed on the non-magnetic substrate which comprises non-magnetic particles and a binder resin; and
a magnetic recording layer formed on the non-magnetic undercoat layer which comprises the ferromagnetic metal particles as defined in claim 1, and a binder resin.
